(19) United States
(12) Patent Application Publication
(10) Pub. No.: US 2022/0224457 A1
(43) Pub. Date: Jul. 14, 2022

(54) NR V2X RETRANSMISSION PROCEDURES

(71) Applicant: Fraunhofer-Gesellschaft zur Förderung der angewandten Forschung e.V., Munich (DE)

(72) Inventors: Roya EBRAHIM REZAGAH, Berlin (DE); Baris GÖKTEPE, Berlin (DE); Sarun SELVANESAN, Berlin (DE); Nithin SRINIVASAN, Berlin (DE); Thomas FEHRENBACH, Berlin (DE); Thomas WIRTH, Berlin (DE); Thomas SCHIERL, Berlin (DE); Cornelius HELLGE, Berlin (DE)

(21) Appl. No.: 17/657,608

(22) Filed: Mar. 31, 2022

Related U.S. Application Data
(63) Continuation of application No. PCT/EP2020/077357, filed on Sep. 30, 2020.

(30) Foreign Application Priority Data
Oct. 2, 2019 (EP) 19201137.7

(51) Int. Cl. H04L 1/18; H04W 72/04; H04L 5/00

(52) U.S. Cl. CPC H04L 1/1893; H04W 72/0406; H04L 5/0055; H04L 1/1812; H04L 1/1887

(57) ABSTRACT

A transceiver for a wireless communication system, the wireless communication system including a plurality of user devices, UEs, to communicate with each other using a sidelink, SL, is described. For a transmission of a packet, like a data packet, using the sidelink, the transceiver is configured to determine one or more transmission requirements for the transmission of the data packet using the sidelink. Responsive to the one or more determined transmission requirements, the transceiver is configured to send one or more control messages, the one or more control messages including one or more of:
A common control message including parameters for a HARQ-based transmission using the sidelink and for a blind or HARQ-free transmission using the sidelink,
A control message including parameters for a blind or HARQ-free transmission using the sidelink.

### CROSS-REFERENCE TO RELATED APPLICATIONS

This application is a continuation of copending International Application No. PCT/EP2020/077357, filed Sep. 30, 2020, which is incorporated herein by reference in its entirety, and additionally claims priority from European Application No. 19201137.7, filed Oct. 2, 2019, which is also incorporated herein by reference in its entirety.

### TECHNICAL FIELD

The present application relates to the field of wireless communication systems or networks, more specifically to enhancements or improvements regarding retransmission procedures, and more specifically in the field of V2X (vehicle-to-everything communication.

Embodiments of the present invention concern NR (New Radio) V2X procedures for blind and HARQ-based (re)transmissions.

### BACKGROUND OF THE INVENTION

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell.

The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device (D2D) communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and one or more of a system information block (SIB), the physical downlink, uplink and sidelink control channels (PDCCH, PUCCH, PSCCH) carrying for example the downlink control information (DCI), the uplink control information (UCI) and the sidelink control information (SCI). Note, the sidelink interface may a support 2-stage SCI. This refers to a first control region containing some parts of the SCI, and optionally, a second control region, which contains a second part of control information.

For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above described terrestrial wireless network also non-terrestrial wireless communication networks (NTN) exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g.

GSM, UMTS, LTE base stations and NR base stations that do not support V2X services.

When considering two UEs directly communicating with each other over the sidelink, e.g. using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

Naturally, in the above-mentioned use cases sidelink communication is not limited to a communication within a group. Rather, the sidelink communication may be among any of UEs, like any pair of UEs.

In mobile communication systems or networks, like those described above with reference to FIG. 1, for example in a LTE or 5G/NR network, the respective entities may communicate using one of more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier, a bandwidth part, BWP, a subband, and the like.

When using a single frequency band, the communication may be referred to as a single-band operation, e.g., a UE transmits/receives radio signals to/from another network entity on frequencies being within the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain. The multi-band operation may include frequency bands in the licensed spectrum, or frequency bands in the unlicensed spectrum, or frequency bands both in the licensed spectrum and in the unlicensed spectrum. Carrier aggregation, CA, is an example using two or more frequency bands in the licensed spectrum and/or in the unlicensed spectrum. 5G New Radio (NR) may support an operation in the unlicensed spectrum so that a multi-band operation may include frequency bands in the unlicensed spectrum bands. This may be as NR-based access to unlicensed spectrum, NR-U, and the frequency bands may be referred to as subbands. The unlicensed spectrum may include bands with a potential IEEE 802.11 coexistence, such as the 5 GHz and the 6 GHz bands. NR-U may support bandwidths that are an integer multiple of 20 MHz, for example due to regulatory requirements. The splitting into the subbands is performed so as to minimize interference with coexisting systems, like IEE 802.11 systems, which may operate in one or more of the same bands with the same nominal bandwidth channels, like 20 MHz channels. Other examples, of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands, Listen-before-talk, LBT, is to be performed separately per subband. This may lead to a situation in which one or more of the subbands are busy or occupied due to an interference, for example, from other communication systems coexisting on the same band, like other public land mobile networks, PLMNs or systems operating in accordance with the IEEE 802.11 specification. In such a situation, the transmitter, either the transmitting gNB or the transmitting UE, is only allowed to transmit on the subbands which are detected to be not busy, also referred to as subbands being free or non-occupied, as is determined by the LBT algorithm. For example for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy or non-won subbands.

It is noted that the information in the above section is only for enhancing the understanding of the background of the invention and therefore it may contain information that does not form known technology that is already known to a person of ordinary skill in the art.

Starting from a known technology as described above, there may be a need for enhancements or improvements in regarding retransmission procedures.

### SUMMARY

An embodiment may have a transceiver for a wireless communication system, the wireless communication system including a plurality of user devices, UEs, to communicate with each other using a sidelink, SL, wherein for a transmission of a packet, like a data packet, using the sidelink, the transceiver is to determine one or more transmission requirements for the transmission of the data packet using the sidelink, responsive to the one or more determined transmission requirements, the transceiver is to send one or more control messages, including a common control message including parameters for a HARQ-based transmission using the sidelink and for a blind or HARQ-free transmission using the sidelink.

Another embodiment may have a user device for a wireless communication system, the wireless communication system including a plurality of user devices, UEs, to communicate with each other using a sidelink, SL, wherein the user device is a transmitting user device, TX UE, served by a base station of the wireless communication system, and is to communicate with one or more receiving user devices, RX UEs, using the sidelink, and for a transmission of a packet, like a data packet, using the sidelink, the TX UE is to receive from the serving base station, dependent on one or more transmission requirements for the transmission of the data packet, one or more control messages, like a DCI, the one or more control messages including common DCI including parameters for a HARQ-based transmission using the sidelink and for a blind or HARQ-free transmission using the sidelink.

According to another embodiment, a wireless communication system may have: one or more inventive base stations as mentioned above, a plurality of inventive user devices, UEs, as mentioned above to communicate with each other using a sidelink, SL, the plurality of UEs including a transmitting UE, TX UE, the TX UE served by the base station and to communicate with one or more receiving UEs, RX UEs, using the sidelink, wherein the TX UE is to receive from the base station the one or more control messages, and is to transmit one or more control messages to the RX UE, and is to then further transmit the packet to the RX UE in accordance with the parameters indicated in the one or more control messages.

### BRIEF DESCRIPTION OF THE DRAWINGS

Embodiments of the present invention are now described in further detail with reference to the accompanying drawings:

FIG. 1a-b shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic diagram for operating of network nodes in Mode 1;

FIG. 5 is an example DAI procedure for scheduling HARQ and blind transmissions;

FIG. 6 is an example representation of a using a DCI containing a single PUCCH location for a total of (MxP) transmissions;

FIG. 7 is an example representation of using DCI containing multiple PUCCH resources corresponding to each of the retransmission resource locations;

FIG. 8 is an example representation of using DCI containing the PUCCH resource location corresponding to a first transmission, for subsequent transmissions, the TX UE will assume the time gap between the resource locations for these transmissions, and will accordingly derive the respective PUCCH locations;

FIG. 9 is a schematic diagram for a multiplexing of HARQ-based and blind/HARQ-less transmissions in a single PUCCH according to an embodiment;

FIG. 10 shows a schematic block diagram for illustrating separating processing of timelines according to an embodiment;

FIG. 11 a schematic representation of operating a network according to an embodiment in which the base station is configured to send to the TX UE a single DCI indicating a HARQ-based transmission, and to receive a single HARQ feedback;

FIG. 12 a schematic representation of operating a network according to an embodiment in which the base station is configured to send to the TX UE a single DCI indicating a HARQ-based transmission, and to receive a single HARQ feedback, wherein the TX UE receives, from an RX UE multiple feedbacks;

FIG. 13 a schematic representation of operating a network according to an embodiment in which the base station is configured to send to the TX UE a single DCI indicating a HARQ-based transmission, and to receive a single HARQ feedback, wherein the TX UE transmits, to an RX UE multiple SCI;

FIG. 14 a schematic representation of operating a network according to an embodiment in which the base station is configured to send to the TX UE a single DCI indicating a HARQ-based transmission, and to receive a single HARQ feedback, wherein the TX UE transmits, to an RX UE multiple SCI and receives, from the RX UE multiple feedbacks;

FIG. 15 a schematic representation of operating a network according to an embodiment in which the base station is configured to send to the TX UE a single DCI indicating a HARQ-based transmission, and to receive a single HARQ feedback, wherein the TX UE transmits, to an RX UE multiple SCI and receives, from the RX UE multiple feedbacks relating to data content;

FIG. 16 a schematic representation of operating a network according to an embodiment in which the base station is configured to send to the TX UE multiple DCI, and to receive multiple HARQ feedback, wherein the TX UE transmits, to an RX UE multiple SCI and receives, from the RX UE a feedback responsive to each SCI;

FIG. 17 a schematic representation of operating a network according to an embodiment in which the base station is configured to send to the TX UE multiple DCI, and to receive multiple HARQ feedback, wherein the TX UE transmits, to an RX UE multiple SCI and receives, from the RX UE a feedback responsive to each data transmission; and

FIG. 18 is a schematic representation of a cell, like a cell in the network of FIG. 1, having a coverage area divided into a plurality of zones; and

FIG. 19 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

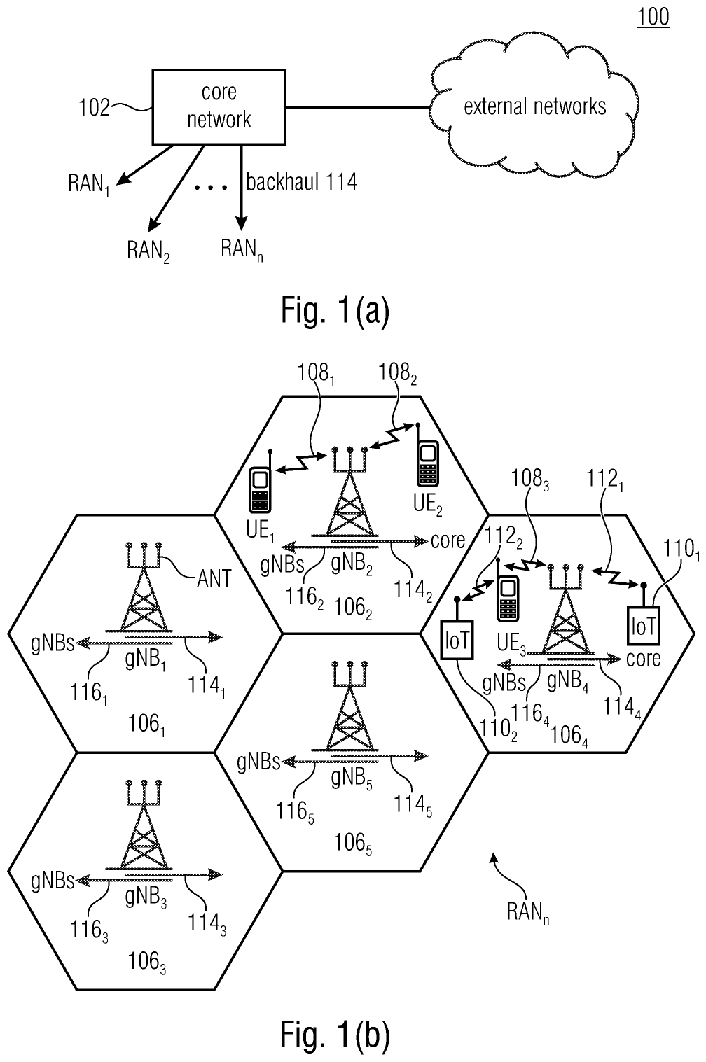

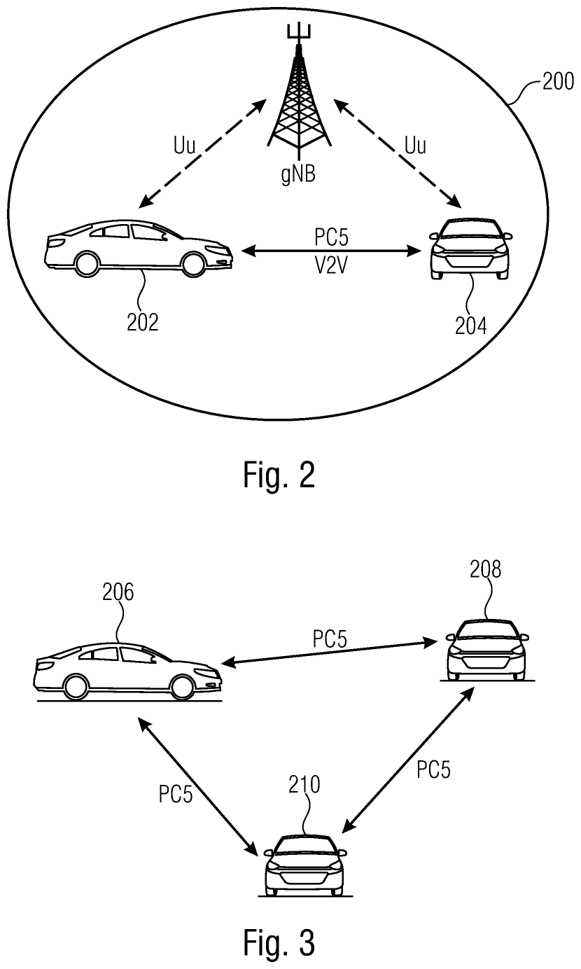

In a wireless communication system or network, like the one described above with reference to FIG. 1. The initial vehicle-to-everything (V2X) specification was included in Release 14 of the 3GPP Standard. The scheduling and assignment of resources have been modified according to the V2X requirements, while the original device-to-device (D2D) communication standard has been used as the basis of the design.

Release 15 of the LTE V2X standards (also known as enhanced V2X or eV2X) was completed in June 2018, and now targeting release 16, 3GPP is looking forward to the first release 5G NR V2X. NR V2X had identified a set of use cases to be achieved and one of the key focus areas for these use cases is to guarantee a certain Quality-of-Service (QoS) for a given application service.

Based on the recently concluded work item for Rel.16, 3GPP has agreed to operate in two configurations from a resource allocation perspective—Mode 1 and Mode 2. V2X UEs operating in Mode 1 to obtain the scheduling information for sidelink (SL) transmissions from the base station (BS/eNB/gNB) whereas Mode 2 UEs autonomously carry out resource selection. It has also been agreed that unicast and groupcast transmissions would support HARQ (hybrid automatic repeat request) feedback, whereas broadcast transmissions would not support this feature. All communication/cast type transmissions also support blind retransmissions, which may be used where the Packet Delay Budget (PDB) does not permit the use of HARQ feedback due to the latency constraints.

Once the resources are allocated, the TX (transmitting) UE has to inform the RX (receiving) UE using Sidelink Control Information (SCI) about the resources allocated for the transmission. It has been agreed that a single SCI would contain information pertaining to only [2, 3 or 4] (re)transmissions, but an overall of 32 (re)transmissions are permissible per packet.

There are two operational modes for NR V2X systems—Mode 1 and Mode 2. V2X Mode 1 configuration involves the scheduling and interference management of resources by the base station (BS/eNB/gNB) for vehicular UEs within the coverage of the said base station to enable sidelink (SL) (vehicle-to-vehicle/V2V) communications. The control signaling is provided to the UE over the Uu interface (via downlink control indicator (DCI)). V2X Mode 2 configuration for SL communications is autonomously performed using distributed (decentralized) algorithms among UEs based on a pre-configured resource configuration.

In Mode 1, the base station is responsible for the selection and allocation of resources to be used by the TX UE for the transmissions (as well as retransmissions) of a packet to the RX UE. The TX UE requests for resources from the base station by using an SR/BSR (scheduling request/buffer status report). On requesting for resources, the base station allocates resources based on higher layer information regarding the priority, reliability and latency requirements attached to the packet. Based on this information, the base station decides the following, and is up to the base station implementation (scheduler) to do so:
whether the packet requires HARQ feedback or blind retransmissions (based on reliability requirements)
number or retransmissions for either scheme above (based on PDB requirements)
resources to be used for (re)transmissions by TX UE (based on availability of resources)
resources to be used in PUCCH (physical uplink control channel) for TX UE to provide feedback to base station (only for HARQ feedback)
the base station then informs the TX UE about the resources to be used for the (re)transmissions by sending a downlink control information (DCI) to the TX UE. In LTE, the DCI contained only the frequency location of the initial transmission and retransmissions, and the time gap between them. This was because the maximum number of transmissions for a packet was restricted to 2. As the maximum number of 32 being read on an NR, the embodiments described herein provide for an efficient solution of a DCI structure.

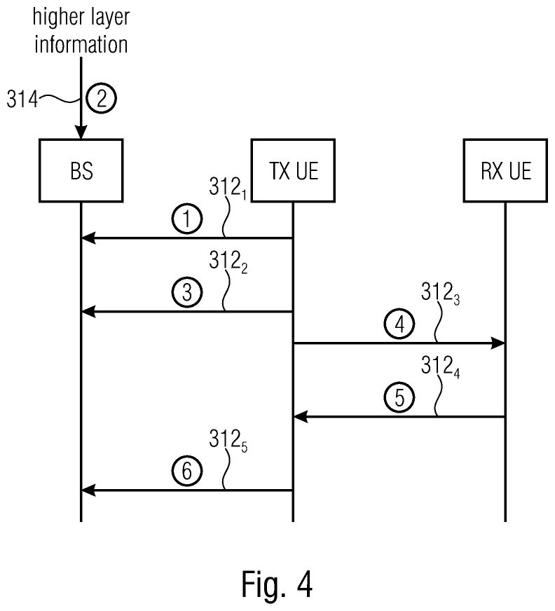

In FIG. 4, a schematic diagram for operating in Mode 1 is illustrated. A base station such as a gNB in FIG. 1 is requested by the TX UE, e.g., one of the UEs or IoT devices of FIG. 1 for resources by receiving a message 312₁. That is, the TX UE sends SR/BSR to the base station. The base station may use higher layer information 314 to decide on key parameters for transmissions. With a message 312₂, the base station may send DCI to the TX UE. With one or more messages 312₃, the TX UE may send SCI and/or data to the RX UE. With one or more respective messages 312₄, the RX UE may send HARQ ACK/NACK to the TX UE. The TX UE may forward HARQ feedback to the base station by one or more respective messages 312₅.

In the case of blind retransmissions, the base station will not provide information regarding the resources to be used for HARQ feedback, but only resources for the actual transmission of the packet, followed by the blind retransmissions.

The TX UE in turn uses this resource information to send a Sidelink Control Information (SCI) to the RX UE to provide information regarding the resources where it can receive the transmissions. The RX UE maintains a timer after the receipt of every (re)transmission. Once a transmission is received, the timer starts. If another transmission of the same packet arrives at the RX UE (with the same HARQ process ID and the New Data Indicator (NDI) stating it is not a new transmission) before the timer runs down, the RX UE will maintain the previous transmission in the buffer and use both the transmissions to decode the packet and restart the timer. The same process is repeated until the RX UE can successfully decode the packet, or the timer runs out and it clears the buffer.

Since the total number of retransmissions (maximum 32) exceeds the number of retransmission resources that can be specified in an SCI (maximum 4), multiple SCIs (and in turn possibly DCIs) would be needed to inform the TX UE (and subsequently the RX UE) about the resources to be used for the retransmissions. Embodiments provide for a procedure for using a single or multiple DCIs for sending SCIs handling multiple (re)transmissions. In connection with the embodiments described herein, this is referred to as Idea 1.3, whilst the new proposed DCI structure in general is explained in embodiments referred to as Idea 1.1 to 1.4.

Further, in the case of HARQ-based retransmissions, the base station has the added responsibility of assigning PUCCH resources to the TX UE so that it can inform the base station of the status (ACK/NACK) of a given transmission. The different procedures to be followed for specifying the retransmission and feedback resources in the DCI is described in embodiments being referred to as idea 1.3.

In the SCI that is transmitted by the TX UE to the RX UE, the instances as to when the HARQ feedback is sent back to the TX UE and the procedure to be followed is described in connection with embodiments being referred to as Idea 4.1. The feedback resources on the PSFCH (Physical Sidelink Feedback Channel) does not need to be specified since there exists an implicit mapping between the data transmitted on the PSFCH and the location of the feedback on the PSFCH as described in European Application EP 19192133.

In Mode 2, the TX UE is responsible for the selection and allocation of resources for transmission to an RX UE. The TX UE is also responsible for deciding whether the packet requires HARQ feedback or blind retransmissions, along with the other decisions described in connection with Mode 1 which are handled by the base station. The procedure followed by the TX UE to make these decisions is described in connection with embodiments being referred to as Idea 5.

For blind retransmissions, the TX UE would simply have to inform the RX UE via SCIs about the resources used for the (re)transmission of the packets. In NR, based on the agreement that an SCI can contain only [2, 3 or 4] retransmission resource locations, multiple SCIs would be required if the total number of retransmissions (maximum 32) exceeds the number of retransmission resources that can be specified in an SCI. It would essentially follow the same procedure as described in connection with the blind retransmissions for Mode 1.

For HARQ-retransmissions, the TX UE can follow the same procedure as described for Mode 1 previously. The RX UE would need to know how long it would have to retain different retransmission versions of the packet until it can clear its buffer. This can be done with a retransmission timer that is either pre-configured or PC5-RRC configured. It starts/resets after a transmission or retransmission and flushes the buffer once it hits the pre-configured threshold.

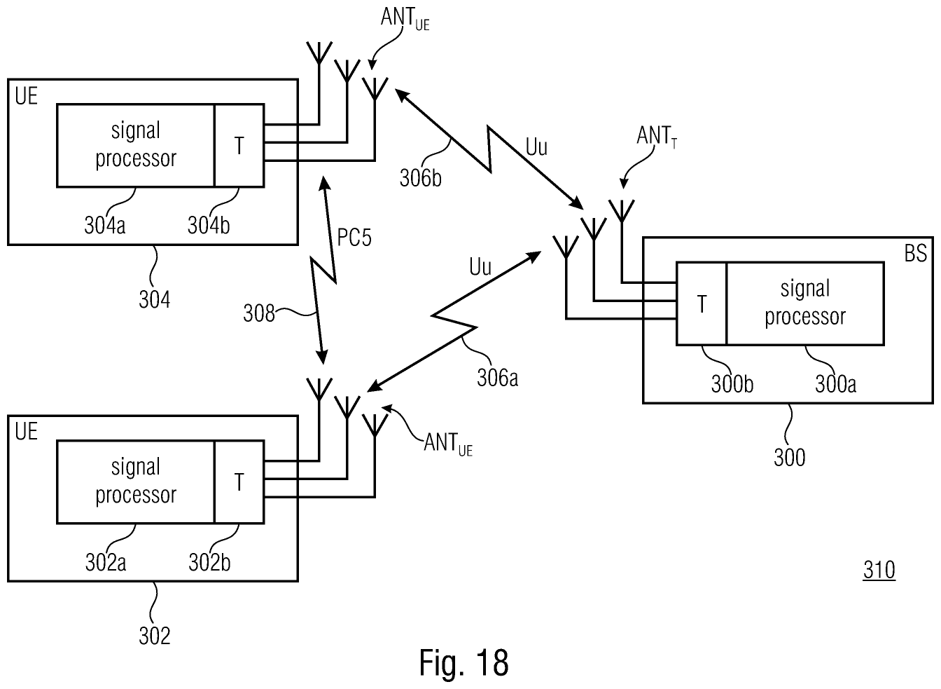

The present invention provides improvements and enhancements in a wireless communication system or network addressing the above described problems by providing for an efficient SCI structure. More specifically, embodiments of the present invention avoid the signaling overhead for providing the location information or position information while still providing the actual location/position with a desired accuracy. Embodiments of the present invention may be implemented in a wireless communication system as depicted in FIG. 1 including base stations and users, like mobile terminals or IoT devices. FIG. 18 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink (SL) interface. When the UEs are not served by the base station, are not be connected to a base station, for example, they are not in an RRC connected state, or, more generally, when no SL resource allocation configuration or assistance is provided by a base station, the UEs may communicate with each other over the sidelink (SL). The system or network of FIG. 18, the one or more UEs 302, 304 and the base stations 300 may operate in accordance with the inventive teachings described herein.

The present invention provides (see for example aspect 1) a transceiver for a wireless communication system, the wireless communication system including a plurality of user devices, UEs, to communicate with each other using a sidelink, SL, wherein for a transmission of a packet, like a data packet, using the sidelink, the transceiver is to determine one or more transmission requirements for the transmission of the data packet using the sidelink,

responsive to the one or more determined transmission requirements, the transceiver is to send one or more control messages, the one or more control messages including one or more of:
a common control message including parameters for a HARQ-based transmission using the sidelink and for a blind or HARQ-free transmission using the sidelink, or
a control message including parameters for a HARQ-based transmission using the sidelink, or
a control message including parameters for a blind or HARQ-free transmission using the sidelink.

In accordance with embodiments (see for example aspect 2), in the transceiver, the one or more transmission requirements include one or more of:
whether the packet requires HARQ feedback or blind retransmissions, e.g., based on reliability requirements, like QoS or channel conditions,
a number of retransmissions for the HARQ feedback scheme and/or for the blind retransmissions scheme, e.g., based on the Packet Delay Budget, PDB, requirements,
resources to be used for the transmission and the retransmissions using the sidelink, e.g., based on an availability of resources, like a congestion situation of the resources.

In accordance with embodiments (see for example aspect 3), the transceiver is to determine the one or more transmission requirements responsive to higher layer information regarding the packet, like the priority, PDB or permissible Packet Error Rate (PER) (relates to the reliability attached to the packet).

In accordance with embodiments (see for example aspect 4), the transceiver is a base station of the wireless communication system communicating with a transmitting UE, TX UE, using the Uu link, the TX UE communicating with one or more receiving UEs, RX UEs, using the sidelink, the transmitting and/or receiving UEs being in NR Mode 1.

In accordance with embodiments (see for example aspect 5), in the transceiver, the base station is to transmit to the TX UE one of more control messages using one or more of:
dynamic grants, where the base station sends a DCI to the TX UE,
configured grants type 1, where the base station configures resources for the TX UE via RRC signaling,
configured grants type 2, where the base station configures resources for the TX UE via RRC signaling, and a DCI is sent in order to activate/deactivate the grant.

In accordance with embodiments (see for example aspect 6), in the transceiver, each of the one or more control messages includes common control message parameters, the common control message parameters including one or more of:
a resource location indication,
a slot aggregation indication,
a total number of retransmissions,
an MCS level,
a maximum TX power,
a destination ID,
a cast type,
transmission procedure indicator e.g. blind-transmission or retransmission, or HARQ enabled transmission,
a priority indication.

In accordance with embodiments (see for example aspect 7), in the transceiver, for a given maximum or allowable number of transmissions and/or retransmissions, e.g., 32 retransmissions in NR SL, the resource location indication includes explicit time and frequency locations of the transmissions and/or one or more retransmissions, wherein, in case the frequency location or subchannel of the initial transmission and the one or more retransmissions are the same, the resource location indication includes at least one of:
a bitmap indicating the time slots in which the retransmissions occur, e.g., in the form of a vector or in the form of an index mapped to a table in the TX UE containing multiple bitmap vectors,
a timing offset, where the receiving UE can then derive the time slots in which the retransmissions occur, until the total number of retransmissions possible is reached.

wherein, in case the frequency locations or subchannels of the initial transmission and the one or more retransmissions are different, the resource location indication includes a time-frequency pattern indicating the time and frequency locations of the resources, e.g., in the form of an index mapped to a table in the TX UE containing multiple time-frequency patterns.

In accordance with embodiments (see for example aspect 8), in the transceiver, the TX UE is configured with a parameter, like a PSSCH-Aggregation Factor parameter, using, for example, RRC signalling, the parameter indicating a number of slots to be aggregated, e.g., for a large packet using multiple PSSCH regions across slots for the transmission of the packet, and the slot aggregation indication indicates only the frequency or subchannel and the starting point of the first slot to be used.

In accordance with embodiments (see for example aspect 9), in the transceiver, a time offset between each of the aggregated slots is pre-configured or configured using semi-static signalling, such as RRC.

In accordance with embodiments (see for example aspect 10), in the transceiver, the control messages is the common control message includes one or more of:
a retransmission type indication indicating whether the one or more retransmissions over the sidelink are HARQ-based retransmissions or blind retransmissions,
a Downlink Assignment Index, DAI,
a retransmission feedback resource location indication indicating the resource locations for transmitting a feedback from the TX UE to the base station, e.g., on the PUCCH.

In accordance with embodiments (see for example aspect 11), in the transceiver, the retransmission type indication is
explicit and includes an explicit parameter indicating whether the packet to be transmitted uses HARQ-based retransmissions or blind retransmissions, or
is implicit by setting one or more certain parameters in the DCI to a predefined or default value

In accordance with embodiments (see for example aspect 12), in the transceiver, in case of an implicit retransmission type indication the use of blind retransmissions is indicated by
using a non-numerical value or a default or pre-configured value for parameters indicating the resources to be used for a feedback from the TX UE to the base station, e.g., in the PUCCH, like a PUCCH resource indicator, or a time gap between the DCI and the feedback, e.g. on the PUCCH, like a PSSCH/PDCCH-to-HARQ-timing indicator, or
a resource location indication for the transmissions and/or retransmissions which points to a set of resources or to a resource pool not including any resources for a PSFCH, and/or

the use of HARQ-based retransmissions is indicated by
a resource location indication for the transmissions and/or retransmissions which points to a set of resources or to a resource pool including resources for a PSFCH;

and/or the use of the destination ID, priority information or cast type e.g. transmission resources for broadcast or a destination ID that has no HARQ configured.

In accordance with embodiments (see for example aspect 13), in the transceiver, the DCI includes a downlink assignment index, DAI, the DAI includes a counter DAI, cDAI, and a total DAI, tDAI, and

in case the DCI is for blind retransmissions using the sidelink
the counter DAI is not incremented or a default or pre-configured value, like −1, is assigned the counter DAI, and/or
the DCI is not counted in the total DAI, and/or
the TX UE is to ignore the counter DAI, and/or
the counter DAI is incremented, but the counter DAI of a following DCI for HARQ-based retransmissions is not incremented.

In accordance with embodiments (see for example aspect 14), in the transceiver, the DCI includes a downlink assignment index, DAI, the DAI includes a counter DAI, cDAI, and a total DAI, tDAI, and

the counter DAI is incremented in case the DCI is for a HARQ-based retransmission and in case the DCI is for a blind retransmission, wherein the transceiver is to increment the counter DAI for a DCI indicating a blind or HARQ-less retransmission and/or retransmission causing a reporting from the TX UE for the HARQ-less or blind transmission.

In accordance with embodiments (see for example aspect 15), in the transceiver,

in case the DCI for the HARQ-less or blind transmission is received correctly at the TX UE, the transceiver is to receive from the TX UE an ACK in the specified PUCCH resource so as to signal that no further resources are required for the given transmission, and to increment the counter DAI, and

in case the DCI for the HARQ-less or blind transmission is received incorrectly at the TX UE, the transceiver is to receive from the TX UE a NACK in the specified PUCCH resource.

In accordance with embodiments (see for example aspect 16), in the transceiver,

in case of blind and HARQ-based retransmissions, the transmission and/or retransmission location indication in a DCI indicates some or all transmission and/or retransmission locations, and

in case of HARQ-based retransmissions alone, the retransmission location indication in a DCI to be send to the TX UE indicates a PUCCH resource on which the TX UE may forward a HARQ feedback the TX UE receives from the RX UE to the base station.

In accordance with embodiments (see for example aspect 17), in the transceiver, in case of HARQ-based retransmissions, the retransmission location indication in a DCI indicates a number of transmission and/or retransmission resource locations, the number of transmission and/or retransmission resource locations is MxP, where MxP does not exceed the maximum or allowable number of transmissions and/or retransmissions, e.g., 32 retransmissions in NR, for a packet, where M is the number of transmission and/or retransmission resource locations contained in a single DCI, where P is the number of DCIs sent for the given packet.

In accordance with embodiments (see for example aspect 18), in the transceiver, the DCI contains a single PUCCH location for M transmission and/or retransmission resource locations, and the transceiver is to
send a DCI, the DCI containing M transmission and/or retransmission resource locations and only one PUCCH location,
receive, responsive to the DCI, from the TX UE a combined feedback of the RX UE for all the M transmissions by using the single PUCCH location,
repeat sending a DCI P times until the feedback indicates a successful decoding of the packet at the RX UE, or until a maximum number, MxP, of retransmissions is reached.

In accordance with embodiments (see for example aspect 19), in the transceiver, the DCI contains multiple PUCCH locations for each of the transmission and/or retransmission resource locations, and the transceiver is to
send a DCI, the DCI containing M transmission and/or retransmission resource locations and a PUCCH location for each transmission and/or retransmission resource location,
receive, responsive to the DCI, from the TX UE a feedback of the RX UE for each of the M transmissions by using the PUCCH location for the transmission and/or retransmission,
repeat sending a DCI P times until the feedback indicates a successful decoding of the packet at the RX UE, or until a maximum number, MxP, of retransmissions is reached.

In accordance with embodiments (see for example aspect 20), in the transceiver, the DCI contains multiple PUCCH locations for a multiple of the transmission and/or retransmission resource locations, and the transceiver is to
send a DCI, the DCI containing MxP transmission and/or retransmission resource locations and a PUCCH location after each M^{th} transmission and/or retransmission resource location,
receive, responsive to the DCI, from the TX UE a feedback of the RX UE after each M^{th} transmissions by using the PUCCH location for the transmission and/or retransmission,
continue to receive feedback from the TX UE after every M transmissions until the feedback indicates a successful decoding of the packet at the RX UE, or until a maximum number, MxP, of retransmissions is reached.

In accordance with embodiments (see for example aspect 21), in the transceiver, the DCI is to indicate explicitly or implicitly, wherein, in case of an explicit indication, the DCI contains all the PUCCH locations for the transmissions and/or retransmissions, wherein, in case of an implicit indication, the DCI contains the PUCCH resource location corresponding to a first transmission, and for subsequent transmissions and/or retransmissions the TX UE is to derive the PUCCH locations for subsequent transmissions and/or retransmissions using at least one of
a time gap between the resource locations for the subsequent transmissions and/or retransmissions, and applying the given time gap with the PUCCH resource location for the first transmission as the starting point, or
a time gap between the initial transmission location and the PUCCH resource location, and applying the given time gap for the subsequent retransmission resource locations.

In accordance with embodiments (see for example aspect 22), in the transceiver, the DCI is to indicate explicitly or implicitly, wherein the transceiver is to indicate in the first DCI
a HARQ-timing indicator which points to a slot where the first HARQ-feedback is to be reported, and
a PUCCH resource indicator, PRI, which indicates one out of multiple configured PUCCH configurations to use for PUCCH transmission within the slot, and wherein one or more slots for a subsequent HARQ-feedback are determined by applying the same offset to the PUCCH resources which is also applied to the PSSCH transmissions.

In accordance with embodiments (see for example aspect 23), the transceiver is to
receive from the TX UE an ACK in case the TX UE determines that all allowable transmissions and/or retransmissions for the packet are completed, or
receive an explicit parameter indicating that all allowable transmissions and/or retransmissions for the packet are completed.

In accordance with embodiments (see for example aspect 24), the transceiver is to, in response to the ACK or the explicit indication, indicating that the transmissions and/or retransmissions for the packet are complete, stop allocating further resources for the packet, independent from the feedback on the PSFCH.

In accordance with embodiments (see for example aspect 25), in the transceiver, the control messages is the control message for HARQ-based retransmissions, the control message for HARQ-based retransmissions including parameters indicating one or more of:
resources to be used in the PUCCH,
a time gap between the DCI and the PUCCH,
a slot offset between the DCI reception and the first sidelink transmission scheduled by the DCI.

In accordance with embodiments (see for example aspect 26), the transceiver is a transmitting UE, TX UE, communicating with one or more receiving UEs, RX UEs, using the sidelink, the transmitting and/or receiving UEs being in NR Mode 2, and the one or more control messages are sidelink control information, SCI, messages comprising sidelink control information, SCI.

In accordance with embodiments (see for example aspect 27), in the transceiver, the one or more transmission requirements further include one or more of:
resources to be used in the PUCCH for the TX UE to provide feedback to the base station in case of HARQ-based transmission using the sidelink,
a time gap between a PDCCH transmission containing the DCI to the TX UE and the PUCCH transmission containing the feedback from the TX UE to the base station,
a slot offset between DCI reception and a first sidelink transmission scheduled by the DCI.

The present invention provides (see for example aspect 28) a user device for a wireless communication system, the wireless communication system including a plurality of user devices, UEs, to communicate with each other using a sidelink, SL, wherein the user device is a transmitting user device, TX UE, served by a base station of the wireless communication system, and is to communicate with one or more receiving user devices, RX UEs, using the sidelink, and

for a transmission of a packet, like a data packet, using the sidelink, the TX UE is to receive from the serving base station, dependent on one or more transmission requirements for the transmission of the data packet, one or more control messages, like a DCI, the one or more control messages including one or more of:
common DCI including parameters for a HARQ-based transmission using the sidelink and for a blind or HARQ-free transmission using the sidelink, or
DCI for HARQ-based retransmissions including parameters for a HARQ-based transmission using the sidelink, or
DCI for HARQ-free retransmissions including parameters for a blind or HARQ-free transmission using the sidelink.

In accordance with embodiments (see for example aspect 29), in the user device, the serving base station comprises or is an inventive transceiver as mentioned above.

In accordance with embodiments (see for example aspect 30), in the user device, the control messages is the common DCI, wherein, responsive to the common DCI, the TX UE is expected to send at least one of the following:
a single SCI with all the resource locations, with an indication that the feedback for each of the transmissions has to be sent, or
multiple SCIs containing a further subset of the resource locations described in the DCI, and specify that feedback has to be sent for each of the transmissions, and wherein TX UE, on receiving the feedback from the RX UE per transmission, will provide the feedback to the base station on the PUCCH resources, which are either implicitly derived or explicitly indicated in the DCI, for the transmission.

In accordance with embodiments (see for example aspect 31), in the user device, the control messages is the common DCI,

wherein, responsive to the common DCI, the TX UE is expected to send the single SCI as an SCI comprising at least two stages.

In accordance with embodiments (see for example aspect 32), in the user device, the control messages is the common DCI,

the DCI includes a downlink assignment index, DAI, the DAI includes a counter DAI, cDAI, to be incremented in case the DCI is for a HARQ-based retransmission and in case the DCI is for a blind retransmission is successfully received at the TX UE,

wherein the TX UE is to send an ACK to the base station in case a DCI for a HARQ-less or blind transmission is successfully received, to cause the base station to increment the counter DAI for the DCI indicating a blind retransmission.

In accordance with embodiments (see for example aspect 33), in the user device, in case unexpected traffic arrives before the HARQ-ACK for a HARQ-less transmission is reported to the base station, and the TX UE needs more resources, the TX UE is to reuse the HARQ-ACK feedback for a blind transmission as a Scheduling Request, SR, to signal the base station the need of more resources, e.g., by transmitting a NACK for the blind transmission in case more resources are required.

In accordance with embodiments (see for example aspect 34), in the user device,

TX UE is to receive from the base station one or more common DCIs indicating slot aggregation, and one or more DCIs for packets that require only a single transmission or one-shot transmission,

in case the slot aggregation on the sidelink is active, the TX UE is to apply the same HARQ timeline for all the transmissions for which the TX UE has to send a HARQ-ACK to the base station, wherein the PSSCH aggregation may be always active or may be activated by the base station using RRC or DCI signaling, the HARQ timeline being for the maximum slot aggregation which is configured or activate for all transmissions,

wherein the HARQ timeline is the time taken from the time the DCI is received by the TX UE to the time the TX UE is ready to send a feedback to the base station, after it has received and decoded the transmission.

The present invention provides (see for example aspect 35) a wireless communication system, comprising

one or more base stations,

a plurality of user devices, UEs, to communicate with each other using a sidelink, SL, the plurality or UEs including a transmitting UE, TX UE, the TX UE to communicate with one or more receiving UEs, RX UEs, using the sidelink,

wherein the base station is to serve the TX UE,

wherein for a transmission of a packet, like a data packet, using the sidelink, the base station is to determine one or more transmission requirements for the transmission of the data packet using the sidelink, and, responsive to the one or more determined transmission requirements, the base station is to send to the TX UE one or more control messages, the one or more control messages including one or more of:
a common control message including parameters for a HARQ-based transmission using the sidelink and for a blind or HARQ-free transmission using the sidelink, or
a control message for HARQ-based retransmissions including parameters for a HARQ-based transmission using the sidelink, or
a control message for HARQ-free retransmissions including parameters for a blind or HARQ-free transmission using the sidelink,

wherein the TX UE is to receive from the base station the one or more control messages, and is to transmit one or more control messages to the RX UE, and is to then further transmit the packet to the RX UE in accordance with the parameters indicated in the one or more control messages.

The present invention provides (see for example aspect 36) a wireless communication system, comprising

one or more inventive base stations as mentioned above,

a plurality of inventive user devices, UEs, to communicate with each other using a sidelink, SL, the plurality of UEs including a transmitting UE, TX UE, as mentioned above, the TX UE served by the base station and to communicate with one or more receiving UEs, RX UEs, using the sidelink,

wherein the TX UE is to receive from the base station the one or more control messages, and is to transmit one or more control messages to the RX UE, and is to then further transmit the packet to the RX UE in accordance with the parameters indicated in the one or more control messages.

In accordance with embodiments (see for example aspect 37), in the wireless communication system,

the base station is to send to the TX UE a single DCI indicating a HARQ-based transmission, transmission and/or retransmission resource locations and a single PUCCH location,

the TX UE is to send to the RX UE a single SCI,

the RX UE is to send to the TX UE single HARQ feedback, wherein the RX UE is to combine all the received retransmissions, and to send a HARQ feedback only after successfully decoding the packets or after the maximum number of retransmissions, and

wherein the TX UE is to relay to the base station a single HARQ feedback using the single PUCCH resource defined in the single DCI.

In accordance with embodiments (see for example aspect 38), in the wireless communication system,

the base station is to send to the TX UE a single DCI indicating a HARQ-based transmission and including a single PUCCH location for the transmission and/or retransmission resource locations,

the TX UE is to send to the RX UE a single SCI,

the TX UE is to receive multiple HARQ feedbacks from the RX UE, but informs the base station only when the RX UE successfully decodes the packet,

wherein the TX UE may schedule a CBG-based transmission including, e.g., several code blocks which are grouped in CBGs, Code Block Groups, to the RX UE using a single SCI, so as to expect multiple feedbacks, e.g., one per each CBG

In accordance with embodiments (see for example aspect 39), in the wireless communication system, the TX UE is to stop sending retransmissions once the RX UE has responded with a positive ACK,

In accordance with embodiments (see for example aspect 40), in the wireless communication system,

the base station is to send to the TX UE a single DCI indicating a HARQ-based transmission and including a single PUCCH location for the transmission and/or retransmission resource locations,

the TX UE is to send to the RX UE multiple SCIs with retransmission resource locations in each SCI,

the RX UE is to combine all the received retransmissions, and is to send a HARQ feedback only after successfully decoding the packets, or after the maximum number of retransmissions, or after a configured or pre-configured number of retransmissions;

the TX UE is to relay to the base station a single HARQ feedback using the single PUCCH resource defined in the single DCI.

In accordance with embodiments (see for example aspect 41), in the wireless communication system,

the base station is to send to the TX UE a single DCI indicating a HARQ-based transmission and including a single PUCCH location for the transmission and/or retransmission resource locations,

the TX UE is to send multiple SCIs with retransmission resource locations in each of the SCIs;
the RX UE is to combine the received transmissions defined in a given SCI, and is to send a HARQ feedback based on the transmissions defined in that SCI;
the TX UE is to relay to the base station a single HARQ feedback using the single PUCCH resource defined in the single DCI.

In accordance with embodiments (see for example aspect 42), in the wireless communication system, the TX UE is to receive the feedback per SCI, and is to stop sending SCIs once the RX UE has responded with a positive ACK.

In accordance with embodiments (see for example aspect 43), in the wireless communication system,

the base station is to send to the TX UE a single DCI indicating a HARQ-based transmission and including a single PUCCH location for the transmission and/or retransmission resource locations,

the TX UE is to send multiple SCIs with retransmission resource locations in each of the SCIs;

the RX UE is to send a HARQ feedback for each of the transmissions,

the TX UE is to relay to the base station a single HARQ feedback using the single PUCCH resource defined in the single DCI.

In accordance with embodiments (see for example aspect 44), in the wireless communication system, the TX UE is to receive all the feedback, and is to stop sending retransmissions and further SCIs once the RX UE has responded with a positive ACK;

In accordance with embodiments (see for example aspect 45), in the wireless communication system,

the base station is to send to the TX UE multiple DCIs indicating a HARQ-based transmission, each including a single PUCCH location for the transmission and/or retransmission resource locations,

the TX UE is to send multiple SCIs with retransmission resource locations in each of the SCIs;

the RX UE is to combine the received transmissions defined in a given SCI, and is to send a HARQ feedback based on the transmissions defined in that SCI;

the TX UE is to receive the feedback per SCI, and is to relay to the base station the feedback using the PUCCH resource defined in the corresponding DCI,

wherein, to receiving a feedback indicating a successful decoding of the packed by the RX UE, the base station is to stop sending DCIs to the TX UE for the said packet.

In accordance with embodiments (see for example aspect 46), in the wireless communication system,

the base station is to send to the TX UE multiple DCIs indicating a HARQ-based transmission, each including a single PUCCH location for the transmission and/or retransmission resource locations,

the TX UE is to send multiple SCIs with retransmission resource locations in each of the SCIs;

the RX UE is to send a HARQ feedback for each of the transmissions;

the TX UE is to receive all the feedback, and to relay to the base station the feedback using the PUCCH resource defined in the corresponding DCI,

wherein the TX UE is to stop SCIs once the RX UE has responded with a positive ACK, and wherein, responsive to the positive feedback, the base station is to stop sending DCIs to the TX UE for the said packet.

In accordance with embodiments (see for example aspect 47), in the wireless communication system, the TX UE is to stop SCIs once the RX UE has responded with a positive ACK, and wherein, responsive to the positive feedback, the base station is to stop sending DCIs to the TX UE for the said packet.

In accordance with embodiments (see for example aspect 48), in the wireless communication system, in case the DCI provides a resource allocation for the initial transmission and for the one or more retransmissions and for a feedback channel, e.g. PUCCH, for the initial transmission and for the one or more retransmissions, the base station, responsive to an ACK for one from the TX UE, is to invalidate all subsequent resource allocations, e.g., for rescheduling the invalidated resources to the same or to another SL UE.

In accordance with embodiments (see for example aspect 49), in the wireless communication system, based on the information provided to the TX UE on a DCI by the base station, the resources are defined in the SCI by one or more of the following:
in case the frequency location or subchannel of the initial transmission and the one or more retransmissions are the same, the resources are defined by at least one of
a bitmap indicating the time slots in which the retransmissions occur, e.g., in the form of a vector or in the form of an index mapped to a table in the RX UE containing multiple bitmap vectors,
a timing offset, where the receiving UE can then derive the time slots in which the retransmissions occur.
in case the frequency locations or subchannels of the initial transmission and the one or more retransmissions are different, the resources are defined by a time-frequency pattern indicating the time and frequency locations of the resources, e.g., in the form of an index mapped to a table in the RX UE containing multiple time-frequency patterns,
Slot aggregation parameter indicating the number of aggregated slots,
DAI parameters.

In accordance with embodiments (see for example aspect 50), in the wireless communication system, when using configured grants, in case some grants contain information regarding the PUCCH and some do not contain information regarding the PUCCH, the TX UE is to
use that the grants that contain PUCCH resources to send feedback back to the base station, and
use the grants that contain no PUCCH resources for blind transmissions.

In accordance with embodiments (see for example aspect 51), in the wireless communication system, when using configured grants, the TX UE is to decide on which grant to transmit the packet dependent on the characteristics of the grant, e.g., dependent on a quality of the resources, the TX UE may use a grant for packets requiring a high or low priority and/or reliability and/or latency.

In accordance with embodiments (see for example aspect 52), in the wireless communication system, when using configured grants, the TX UE is to decide on which grant to transmit the packet dependent on the communication type, e.g., dependent on a conditions of the resources, the TX UE may use a grant for packets related to broadcast, groupcast or unicast transmissions.

In accordance with embodiments (see for example aspect 53), in the wireless communication system,

the UE comprise one or more of
a mobile terminal, or
stationary terminal, or
cellular IoT-UE, or
vehicular UE, or
vehicular group leader (GL) UE
an IoT or narrowband IoT, NB-IoT, device, or
a ground based vehicle, or
an aerial vehicle, or
a drone, or
a moving base station, or
road side unit (RSU), or
a building, or
any other item or device provided with network connectivity enabling the item/device to communicate using the wireless communication network, e.g., a sensor or actuator, or
any other item or device provided with network connectivity enabling the item/device to communicate using a sidelink the wireless communication network, e.g., a sensor or actuator, or
any sidelink capable network entity, and/or

wherein the base station comprises one or more of
a macro cell base station, or
a small cell base station, or
a central unit of a base station, or
a distributed unit of a base station, or
a road side unit (RSU), or
a UE, or
a group leader (GL)
a relay or
a remote radio head, or
an AMF, or
an SMF, or
a core network entity, or
mobile edge computing (MEC) entity, or
a network slice as in the NR or 5G core context, or
any transmission/reception point, TRP, enabling an item or a device to communicate using the wireless communication network, the item or device being provided with network connectivity to communicate using the wireless communication network.

The present invention provides (see for example aspect 54) a method for operating a transceiver in a wireless communication system, the wireless communication system including a plurality of user devices, UEs, to communicate with each other using a sidelink, SL, wherein the method comprises:

for a transmission of a packet, like a data packet, using the sidelink, the transceiver is to determine one or more transmission requirements for the transmission of the data packet using the sidelink,

responsive to the one or more determined transmission requirements, sending one or more control messages, the one or more control messages including one or more of:
a common control message including parameters for a HARQ-based transmission using the sidelink and for a blind or HARQ-free transmission using the sidelink, or
a control message including parameters for a HARQ-based transmission using the sidelink, or
a control message including parameters for a blind or HARQ-free transmission using the sidelink.

The present invention provides (see for example aspect 55) a method for operating a user device in a wireless communication system, the wireless communication system including a plurality of user devices, UEs, to communicate with each other using a sidelink, SL, wherein the user device is a transmitting user device, TX UE, served by a base station of the wireless communication system, wherein the method comprises:

communicating, with the TX UE with one or more receiving user devices, RX UEs, using the sidelink, and

for a transmission of a packet, like a data packet, using the sidelink, receive, with the TX UE, from the serving base station, dependent on one or more transmission requirements for the transmission of the data packet, one or more control messages, like a DCI, the one or more control messages including one or more of:
common DCI including parameters for a HARQ-based transmission using the sidelink and for a blind or HARQ-free transmission using the sidelink, or
DCI for HARQ-based retransmissions including parameters for a HARQ-based transmission using the sidelink, or
DCI for HARQ-free retransmissions including parameters for a blind or HARQ-free transmission using the sidelink.

The present invention provides (see for example aspect 56) a method for operating a wireless communication system comprising one or more base stations, a plurality of user devices, UEs, to communicate with each other using a sidelink, SL, the plurality or UEs including a transmitting UE, TX UE, the TX UE to communicate with one or more receiving UEs, RX UEs, using the sidelink, the method comprising:

serving the TX UE with the base station,

for a transmission of a packet, like a data packet, using the sidelink, determining, with the base station, one or more transmission requirements for the transmission of the data packet using the sidelink, and, responsive to the one or more determined transmission requirements, sending, with the base station, to the TX UE one or more control messages, the one or more control messages including one or more of:
a common control message including parameters for a HARQ-based transmission using the sidelink and for a blind or HARQ-free transmission using the sidelink, or
a control message for HARQ-based retransmissions including parameters for a HARQ-based transmission using the sidelink, or
a control message for HARQ-free retransmissions including parameters for a blind or HARQ-free transmission using the sidelink,

receiving, with the TX UE, from the base station the one or more control messages, and transmitting, with TX UE, one or more control messages to the RX UE, and then further transmit the packet with the TX UE to the RX UE in accordance with the parameters indicated in the one or more control messages.

The present invention provides (see for example aspect 57) a method for operating a wireless communication system, comprising one or more inventive base stations as mentioned above, a plurality of inventive user devices, UEs, to communicate with each other using a sidelink, SL, the plurality of UEs including a transmitting UE, TX UE, as mentioned above, the method comprising:

serving the TX UE by the base station and communicating, with the TX UE, with one or more receiving UEs, RX UEs, using the sidelink,

receiving, with TX UE, from the base station the one or more control messages, and transmitting, with the TX UE, one or more control messages to the RX UE, and then further transmitting the packet with the TX UE to the RX UE in accordance with the parameters indicated in the one or more control messages.

The present invention provides (see for example aspect 58) a non-transitory computer program product comprising a computer-readable medium storing instructions which, when executed on a computer, perform the inventive methods as mentioned above.

Computer Program Product

Embodiments of the present invention provide a computer program product comprising instructions which, when the program is executed by a computer, causes the computer to carry out one or more methods in accordance with the present invention.

Embodiments described herein relate to ideas that allow to enhance NR V2X to cater to multiple blind and HARQ (re)transmissions in Mode 1 and Mode 2.

Embodiments provide for a transceiver for a wireless communication system, the wireless communication system including a plurality of user devices, UEs, to communicate with each other using a sidelink, SL. For a transmission of a packet, like a data packet, using the sidelink, the transceiver is to determine one or more transmission requirements for the transmission of the data packet using the sidelink. Responsive to the one or more determined transmission requirements, the transceiver is to send one or more control messages, the one or more control messages including one or more of:
a common control message including parameters for a HARQ-based transmission using the sidelink and for a blind or HARQ-free transmission using the sidelink, and/or
a control message including parameters for a HARQ-based transmission using the sidelink, and/or
a control message including parameters for a blind or HARQ-free transmission using the sidelink.

In other words, based on the working on NR Uu, every DCI would contain a PUCCH resource allocation for the feedback to be sent by the TX UE to the base station. If this is carried over to NR V2X, the embodiments described therein means that when “blind” or “HARQ-less” transmission takes place, it is referring only to the PC5 communication link. It means that although the base station would provide PUCCH resources for feedback on the DCI (as mandated by the Uu workings), the base station can also instruct the TX UE to carry out blind or HARQ-less transmissions to the RX UE via sidelink PC5.

Again, based on the understanding of the specification's progress, the information conveyed by the base station to the TX UE is carried out in three possible methods:
using dynamic grants, where the base station sends a DCI to the TX UE, e.g., corresponding to one packet for sidelink transmission with feedback reporting to the base station,
using configured grants of type 1, where the base station configures resources for the TX UE via RRC signaling,
using configured grants of type 2, where the base station configures resources for the TX UE via RRC signaling, and a DCI is sent in order to activate/deactivate the grant.

Based on this understanding, Ideas 1.2, 1.3 state that they are new parameters for DCI, but can also be used for the RRC signaling. Similarly, in Idea 4, when the base station sends the DCI to the TX UE, it also possible for the base station to send RRC signals instead.

The described transceiver may be, for example, a UE or IoT device of a network and may operate, for example, in a network as described in FIG. 1, the network being adapted according to the embodiments described therein.

Idea 1

According to an embodiment, the one or more transmission requirements include one or more of:
whether the packet requires HARQ feedback or blind retransmissions, e.g., based on reliability requirements, like QoS or channel conditions,
a number of retransmissions for the HARQ feedback scheme and/or for the blind retransmission scheme, e.g., based on the packet delay budget, PDB, requirements,
resources to be used for the transmission and the retransmissions using the sidelink, e.g., based on an availability of resources, like a congestion situation of the resources.

Alternatively or in addition, the transceiver may be configured to determine the one or more transmission requirements responsive to higher layer information regarding the packet, like the priority, PDB or permissible packet error rate (PER) or other information relating to the reliability attached to the packet.

In other, general words, Idea 1 relates to Mode 1-DCI structure. The base station decides the following, and is up to the base station implementation (scheduler) to do so:
whether the packet requires HARQ feedback or blind retransmissions (based on reliability requirements)
number of retransmissions for either scheme above (based on PDB requirements)
resources to be used for (re)transmissions by TX UE (based on availability of resources)
resources to be used in PUCCH for TX UE to provide feedback to the base station (only for HARQ feedback)
a time gap between the PDCCH transmission containing the DCI to the TX UE and the PUCCH transmission containing the feedback from the TX UE to the base station
a slot offset between DCI reception and the first sidelink transmission scheduled by DCI.

Parameters required to indicate the resources to be used in PUCCH, the time gap between the DCI and the PUCCH, and the slot offset between the DCI reception and the first sidelink transmission scheduled by DCI may be used, for example, according to 3GPP where they were discussed and agreed. A transceiver in accordance with Idea 1 may be implemented as a base station of the wireless communication system communicating with a transmitting UE, TX UE, using the Uu link, the TX UE communicating with one or more receiving UEs, RX UEs using the sidelink, the transmitting and/or receiving UEs being in NR Mode 1.

Idea 1.1—DCI Formats

To further specify Idea 1, embodiments relating to DCI formats are described in connection with Idea 1.1. The described transceiver being a base station may be implemented such that the one or more transmission requirements further include one or more of:
resources to be used in the PUCCH for the TX UE to provide feedback to the base station in case of HARQ-based transmission using the sidelink
a time gap between a PDCCH transmission containing the DCI to the TX UE and the PUCCH transmission containing the feedback from the TX UE to the base station,
a slot offset between DCI reception and a first sidelink transmission scheduled by the DCI.

In connection with this idea but not limited to Idea 1.1, the base station may be implemented to transmit, to the TX UE, one or more control information using one or more of:
dynamic grants where the base station sends a DCI to the TX UE
configured grants of type 1, where the base station configures resources for the TX UE via RRC signaling,
configured grants of type 2, where the base station configures resources for the TX UE via RRC signaling, and a DCI is sent in order to activate/deactivate the grant.

In other words, Idea 1.1 relates to DCI formats. Once the base station has made the above listed decisions required for the transmission of a packet, it has to convey this information to the TX UE via a new DCI format in accordance with embodiments. Embodiments propose that the DCI format itself can be defined in one of two basic methods/ways:
using a single common DCI format;
using different DCI formats for HARQ-based retransmissions and blind retransmissions

Using a single DCI format is advantageous since it reduces the blind decoding complexity at the UE side, but its size would be larger to cater to both HARQ-based and blind retransmissions.

Since additional parameters are required for HARQ-based retransmissions as compared to blind retransmissions, the report divides into common parameters which are required in the DCI, immaterial of whether a single DCI format is used, or different formats are used. This is followed by sections describing parameters used for each of the DCI formats.

Idea 1.2—Common Parameters

In accordance with Idea 1.1, in particular in connection with the transceiver being implemented as a base station, each of the one or more control messages includes common control message parameters, the common control message parameters including one or more of:
a resource location indication,
a slot aggregation indication,
a total number of retransmissions
an MCS level (modulation coding scheme),
a maximum TX power,
a destination ID (of the receiver),
a cast type,
a transmission procedure indicator, e.g., blind transmission or retransmission, or
a priority indication.

Optionally, the transceiver may further be implemented such that, for a given maximum or allowable number of transmissions and/or retransmissions, e.g., 32 retransmissions in NR SL, the resources location indication includes time and frequency locations of the retransmissions and/or one or more retransmissions. In case, the frequency location or subchannel of the initial transmission and the one or more retransmissions are the same, the resource location indication may include at least one of:
a bitmap indicating the time slots in which the retransmissions occur, e.g., in the form of a vector or in the form of an index mapped to a table in the TX UE containing multiple bitmap vectors,
a timing offset, where the receiving UE can then derive the time slots in which the retransmissions occur, until the total number of retransmissions possible is reached.

It is possible for the timing offset to be defined in the DCI or configured via RRC configurations as well.

In case, the frequency locations or subchannels of the initial transmissions and the one or more retransmissions are different, the resource location indication may include a time-frequency pattern indicating the time and frequency locations of the resources, e.g., in the form of an index mapped to a table in the TX UE containing the multiple time-frequency patterns.

According to an embodiment, the described TX UE may be configured with a parameter, like a PSSCH (Physical Sidelink Shared Channel)-Aggregation Factor parameter, using, for example, RRC signaling, the parameter indicating a number of slots to be aggregated, e.g., for a large packet using multiple PSSCH regions across slots for the transmission of the packet, and the slot aggregation indication indicates only the frequency or subchannel and the starting point of the first slot to be used.

In other words, common parameters for the DCI may be commonly used in the new DCI format, even if there is only one DCI format defined, or if there are multiple DCI formats defined, e.g., two formats—one for HARQ-based retransmissions and one for blind retransmissions.

Resource Location Indication in DCIs

Given that the maximum number of retransmissions has increased from two (LTE) to 32 (in NR), the explicit time and frequency locations of the transmissions are to be defined. In order to achieve this, embodiments propose that the resources can be defined in the DCI in at least one of the following methods:
if the frequency location (subchannel) of the initial and retransmissions are the same, a bitmap can be used for indicating the time slots in which the retransmissions would occur. The bitmap can be indicated in the DCI in the form of
   a vector, or
   an index, mapped to a table containing multiple bitmap vectors
if the frequency location (subchannel) of the initial and retransmissions are the same, the time slots in which the retransmissions would occur may be derived implicitly based on one or more of preconfigured or semi-statically configured or dynamically indicated parameters
   a number of (re-)transmission locations
   a time offset between the (re-)transmission locations
if the frequency locations are different, a time-frequency pattern can be used to indicate the time and frequency locations of the resources. This can be indicated in the form of an index mapped to a table containing multiple time-frequency patterns.

Slot Aggregation Indication

The slot aggregation indication may be implemented independently from the resource location indication in DCIs. In the case where large packets have to be transmitted, it is possible for slot aggregation—where multiple PSSCH regions across slots are used for the transmission of the packet. The number of slots to be aggregated in such a case may be defined by a PSSCH-Aggregation Factor parameter, which can be configured, e.g., by RRC signaling. The timing offset, e.g. 0 to X slots, between the aggregated slots may be preconfigured or configured semi-statically, e.g. by RRC signaling. In this case, embodiments propose the DCI to contain the following parameter:
the DCI specifies only the frequency (subchannel) and the starting point (explicitly or implicitly) of the first slot to be used for sending the large packet. Together with a configured PSSCH-Aggregation Factor (for a dedicated ID), the UE knows for how many slots are applied for the same resource allocation, i.e., the number of slots that are aggregated.

A time offset between each of the aggregated slots may pre-configured and/or configured using semi-static signalling, such as RRC.

Idea 1.3—Parameters for Common New DCI Format

To keep the blind decoding effort at the Mode 1 TX low, the network may decide to configure the UE with a single DCI format for scheduling SL transmissions. Embodiments related hereto provide for apparatuses and methods to interpret the values of certain parameters for blind and HARQ-based transmissions.

According to an embodiment, the transceiver such as the one being implemented as a base station, is implemented such that the control message is the common control message and includes, as listed earlier as well, one or more of:
a retransmission type indication indicating whether the one or more retransmissions over the sidelink HARQ-based retransmissions or blind retransmissions,
a Downlink Assignment Index DAI,
a retransmission feedback resource location indication indicating the resource locations for transmitting a feedback from the TX UE to the base station, e.g., on the PUCCH.

According to an embodiment, such a transceiver may be implemented such that the retransmission type indication is
explicit and includes an explicit parameter indicating whether the packet to be transmitted uses HARQ-based retransmissions or blind retransmissions, or
is implicit by setting one or more certain parameters in the DCI to a predefined or default value.

According to an embodiment, in case of an implicit retransmission type indication, the use of blind retransmissions may be indicated by:
using a non-numerical value or a default or pre-configured value for parameters indicating the resources to be used for a feedback from the TX UE to the base station, e.g., in the PUCCH, like a PUCCH resource indicator, or a time gap between the DCI and feedback, e.g., on the PUCCH, like a PSSCH/PDCCH-to-HARQ-timing indicator, or
a resource location indication for the transmissions and/or retransmissions which points to a set of resources or to a resource pool not including any resources for a PSSCH, and/or The use of HARQ-based retransmissions is indicated by
A resource location indication for the transmissions and/or retransmissions which points to a set of resources or to a resource pool including any resources for a PSSCH.

Alternatively or in addition, the use of the destination ID, priority information or cast type, e.g., transmission resources for a broadcast or a destination ID that has no HARQ configured may be indicated.

According to an embodiment, the DCI may include a Downlink Assignment Index, DAI, the DAI including a counter DAI, cDAI, and a total DAI, tDAI. In case, the DCI is for blind retransmissions using the sidelink,
the counter DAI is not incremented or a default or a pre-configured value, like −1, is assigned to the counter DAI, and/or
the DCI is not counted in the total DAI, and/or
the TX UE is to ignore the counter DAI, and/or
the counter DAI is incremented, but the counter DAI of a following DCI for HARQ-based retransmissions is not incremented.

In other words, for HARQ-based and/or blind retransmission indication, the DCI format may cater to both HARQ-based retransmissions as well as blind retransmissions, and hence a parameter may be defined to inform the TX UE which type of retransmission is to be used for a particular packet.
an explicit parameter indicating whether the packet to be transmitted would use HARQ-based transmission and/or blind retransmissions.

This indication can also be carried out by an implicit manner, by setting certain default values for other parameters in the DCI:
implicit indication for using blind retransmissions by using a non-numerical value or a default pre-configured value for the parameters indicating the resources to be used in PUCCH, e.g., PUCCH resource indicator, and/or the time gap between the DCI and the PUCCH, e.g., PSSCH/PDCCH-to-HARQ-Timing-Indicator;
implicit indication based on the resource location parameter,
   if the resources are pointing to a resource pool with PSFCH (Physical Shared Feedback Channel) defined, the TX UE can assume that the packet to be transmitted would use HARQ-based retransmissions, unless specified otherwise,
   if the resources are pointing to a resource pool without PSFCH defined, the TX UE can assume that the packet to be transmitted would use blind retransmissions, unless specified otherwise.

In connection with the Downlink Assignment Index (DAI), depending on which HARQ reporting mechanism to report the SL feedback to the base station is used, the network may employ a method similar to Downlink Assignment indicator (DAI) in the DCI scheduling a SL grant, e.g., for dynamic HARQ-ACK codebook.

NR uses the Downlink Assignment Index DAI included in the DCI. The DAI field is further split into two parts, a counter DAI (cDAI) and, in the case of carrier aggregation, a total DAI (tDAI). The counter DAI included in the DCI may indicate the number of scheduled Downlink Transmissions up to the point the DCI was received in a carrier first, time second manner. The total DAI included in the DCI may indicate the total number of downlink transmissions across all carriers up to this point in time, that is, the highest cDAI at the current point in time.

For these parameters to be used in a common DCI format, embodiments propose the following:
for a DCI meant for blind retransmissions, the counter DAI is not incremented and/or the DCI is not counted in the total DAI
   it is also possible for a default or pre-configured value, e.g., −1 to be assigned to this parameter
   the TX UE can also choose to ignore this field
alternatively, the counter DAI for a blind retransmission is incremented, but the counter DAI of the following SL grant with HARQ is not incremented.

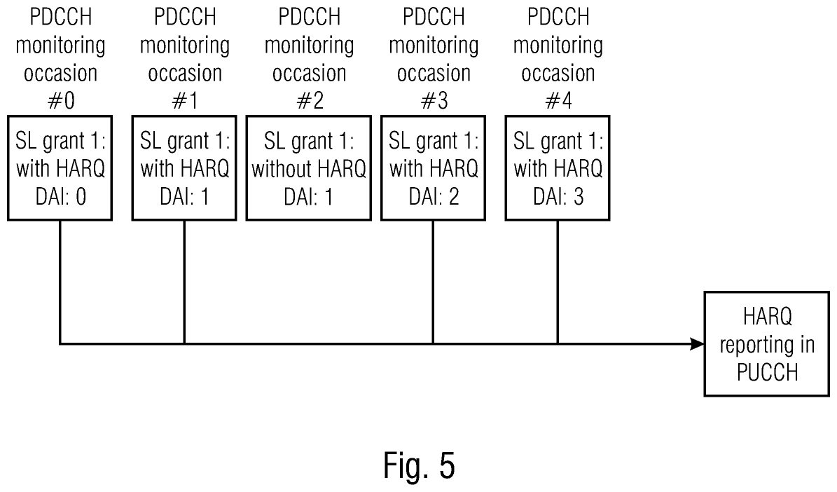

As depicted, for example, in FIG. 5, the non-incrementing, or assigning a default value, of DAI helps the UE to report correctly to the base station. For example, if the UE misses the DCI scheduling a SL grant in PDCCH monitoring occasion #1, it can recover from PDCCH monitoring occasion #2 that there was a DCI with HARQ in between for which HARQ feedback was requested. However, if the UE misses the DCI on PDCCH monitoring occasion #2, it will not be aware of the grant. This is not such a critical issue since it does not have to report for this transmission to the base station and the UE has to send a SR/BSR for a new grant anyway.

FIG. 5 shows a DAI procedure for scheduling HARQ and blind transmissions.

The procedure allows for a failsafe for the case in which a UE misses a DCI concerning HARQ.

Indication on PUCCH

In the case of blind retransmissions, it is possible for a single DCI to transmit all the retransmission locations. The base station can also choose to send multiple DCIs containing a subset of the retransmission resource locations, with the locations indicated in the above-mentioned methods.

In the case of HARQ-based retransmissions, each DCI that is sent to the TX UE may also indicate a PUCCH resource on which the TX UE can forward the HARQ feedback it received from the RX UE to the base station. It is inefficient to allocate PUCCH resources for each of the retransmissions in a single DCI, since the overhead and size of the DCI would increase.

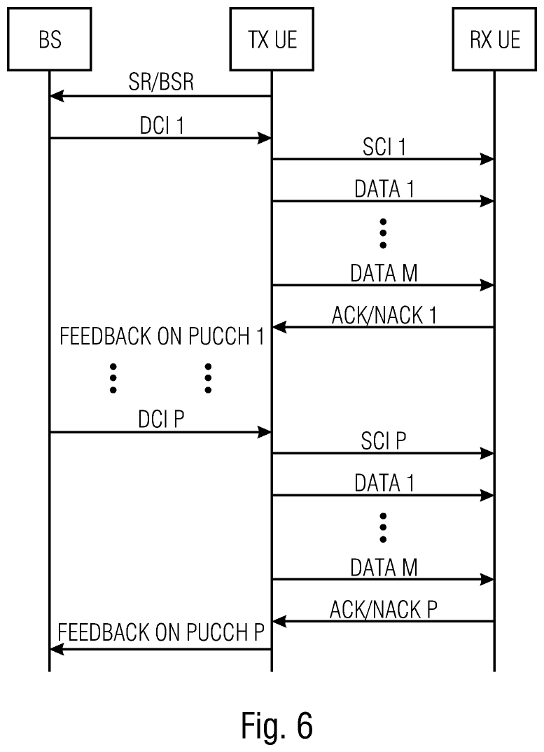

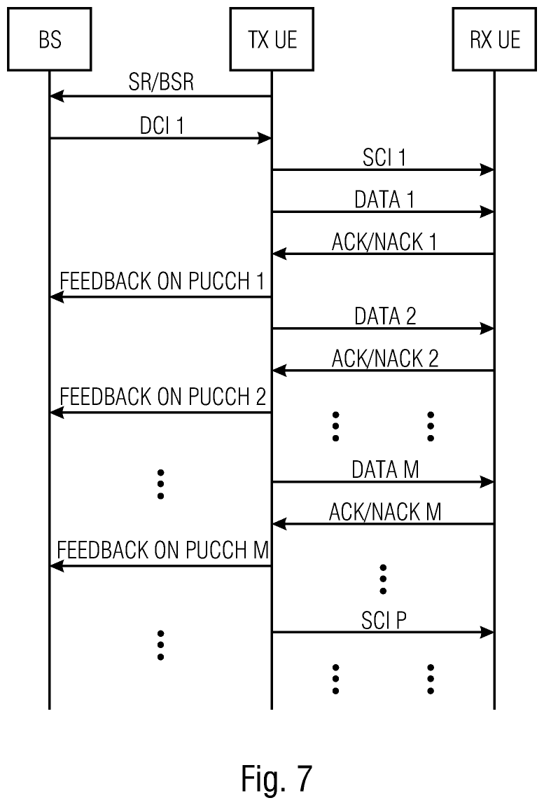

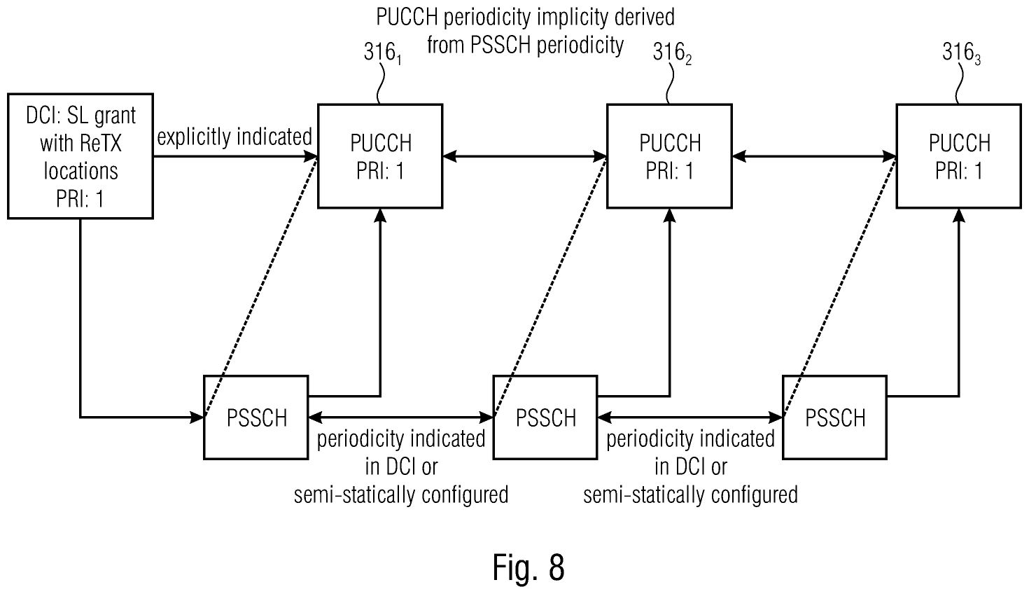

Embodiments therefore propose that the number of retransmission resource locations which are to be indicated in a DCI can be quantized to be a multiple of the total number of retransmissions attached to the particular packet. For each of the DCIs, the location of the PUCCH can be defined in one of the following methods:
Each DCI contains a single PUCCH location for a total of (MxP) transmissions as illustrated in FIG. 6
   In this method, each DCI contains a subset of the retransmission resource locations (M) and only one PUCCH location
   TX UE receiving this DCI is expected to send an SCI to the RX UE with the resource locations
   The RX UE in turn will attempt to receive all the M transmissions in the defined resource locations and then soft-combine the transmissions
   Based on whether the RX UE was able to decode the packet successfully or not, it was sent an ACK/NACK back to the TX UE
   This is then relayed back to the base station by using the single PUCCH location that was defined in the DCI
   The process may be repeated P times until the RX UE successfully decodes the packet, or the maximum number of retransmissions (MxP) is reached
Each DCI may contain multiple PUCCH resources corresponding to each of the retransmission resource locations as illustrated in FIG. 7.
   According to this method, the DCI contains a subset of the retransmission resource locations and a PUCCH location for each of the resource locations
   The indication of the PUCCH locations for the respective feedback can be done in an implicit or explicit manner, for example according to:
      Explicit manner: the DCI will contain all the PUCCH locations for each of the (re)transmissions
      Implicit manner 1: the DCI will contain the PUCCH resource location corresponding to the first transmission. For subsequent transmissions, the TX UE will assume the time gap between the resource locations for these transmissions, and will accordingly derive the respective PUCCH locations as illustrated, for example, in FIG. 8.
      The DCI can also derive the PUCCH resource locations based on the time gap between the initial transmission location and the PUCCH resource location, and applying the given time gap for the subsequent retransmission resource locations.
      The base station indicates in the first DCI the HARQ-timing indicator which points to the slot where the first HARQ-ACK is to be reported and specifies also a PUCCH resource indicator, PRI, 316₁, which indicates one out of the multiple configured PUCCH configurations to use for PUCCH transmission within said slot.
      In the implicit approach, only the timing points to the first PUCCH resource and the subsequent PUCCH resources are determined by applying the same offset to the PUCCH resources which is also applied to the PSSCH transmissions.
      Further parameters, such as the PRI, are also taken over from the first PUCCH for HARQ-ACK reporting. FIG. 8 thus shows an implicit derivation of subsequent PUCCH resources 316₂, and 316₃ based on the first one.
      For a maximum number of 32 DCI, with a single SCI allowing for indicating at most four transmissions, at most four SCIs may be needed. Thus, the implicit manner allows for a reduction of messages to be transmitted.
The procedure followed by the TX UE on receiving the DCI can be carried out in one of two methods:
   The TX UE is expected to send a single SCI with all the resource locations, with an indication that the feedback for each of the transmissions have to be sent.
   The TX UE is expected to send multiple SCIs containing a further subset of the resource locations described in the DCI, and specify that feedback has to be sent for each of the transmissions.
The RX UE will accordingly provide feedback for each of the transmissions. The TX UE, on receiving the feedback from the RX UE per transmission, will provide the feedback to the base station on the PUCCH resources, which are either implicitly derived or explicitly indicated, for each transmission.
In connection with Idea 1.3, a transceiver may, in case of blind and HARQ-based retransmissions, the transmission and/or retransmission location indication in a DCI may indicate some or all transmission and/or retransmission locations. In case of HARQ-based retransmissions alone, the retransmission location indication in a DCI to be sent to the TX UE may indicate a PUCCH resource on which the TX UE may forward an HARQ feedback the TX UE receives from the RX UE to the base station.

According to an embodiment, such a transceiver may be implemented such that, in case of HARQ-based retransmissions, the retransmission location indication in a DCI may indicate a number of transmission and/or retransmission resource locations, the number of transmission and/or retransmission resource locations is MxP, where MxP does not exceed the maximum or allowable number of transmissions and/or retransmissions, e.g., 32 retransmissions in in NR, for a packet, where M is the number of transmission and/or retransmission resource locations contained in a single DCI, where P is the number of DCIs sent for the given packet.

According to an embodiment, such a transceiver may be implemented such that the DCI contains a single PUCCH location for M transmission and/or retransmission resource locations, wherein the receiver is configured to
send a DCI, the DCI containing M transmission and/or retransmission resource locations and only one PUCCH location,
receive, response to the DCI from the TX UE a combined feedback of the RX UE for all the M transmissions by using the single PUCCH location,
repeating sending a DCI P times until the feedback indicates a successful decoding of the packet at the RX UE, or until a maximum number, MxP, of retransmissions is reached.

According to an embodiment, such a transceiver may be implemented such that the DCI contains multiple PUCCH locations corresponding to each of the transmission and/or retransmission resource locations, and the transceiver is to
send a DCI, the DCI containing M transmission and/or retransmission resource locations and a PUCCH location for each transmission and/or retransmission resource location,
receive, responsive to the DCI, from the TX UE a feedback of the RX UE for each of the M transmissions by using the PUCCH location for the transmission and/or retransmission,
repeat sending a DCI P times until the feedback indicates a successful decoding of the packet at the RX UE, or until a maximum number, MxP, of retransmissions is reached.

According to an embodiment, the transceiver may be implemented such that the DCI contains multiple PUCCH locations for a multiple of the transmission and/or retransmission resource locations, but not each of them, and the transceiver is to
send a DCI, the DCI containing MxP transmission and/or retransmission resource locations and a PUCCH location after each M^{th} transmission and/or retransmission resource location,
receive, responsive to the DCI, from the TX UE a feedback of the RX UE after each M^{th} transmissions by using PUCCH location for the transmission and/or retransmission,
continue to receive feedback from the TX UE after every M transmissions until the feedback indicates a successful decoding of the packet at the RX UE, or until a maximum number, MxP, of retransmissions is reached.

According to an embodiment, the DCI is to indicate explicitly or implicitly. In case of an explicit indication, the DCI may contain all of the PUCCH locations for the transmissions and/or retransmissions. In case of an implicit indication, the DCI may contain the PUCCH resource location corresponding to a first transmission, and for subsequent transmissions and/or retransmissions. The TX UE is to derive the PUCCH locations for subsequent transmissions and/or retransmissions using at least one of
a time gap between the resource locations for the subsequent transmissions and/or retransmissions, and applying the given time gap with the PUCCH resource location for the first transmission as the starting point, or
a time gap between the initial transmission location and the PUCCH resource location, and applying the given time gap for the subsequent retransmission resource locations.

According to an embodiment, the DCI is to indicate explicitly or implicitly. The transceiver is to indicate in the first DCI
an HARQ-timing indicator which points to a slot where the first HARQ-feedback is to be reported, and
a PUCCH resource indicator, PRI, which indicates one of multiple configured PUCCH configurations to use for PUCCH transmission within the slot.

One or more slots for subsequent HARQ-feedback are determined by applying the same offset to the PUCCH resources, which is also applied to the PSSCH transmissions.

Accordingly, in response to the common DCI, the TX UE may be expected to send at least one of a single SCI with all the resource locations, with an indication that the feedback for each of the transmissions to be sent, or multiple SCIs containing a further subset of the resource locations described in the DCI, and specify that feedback has to be sent for each of the transmissions. The TX UE, on receiving the feedback from the RX UE per transmission, may provide the feedback to the base station on the PUCCH resources, which are either implicitly derived or explicitly indicated in the DCI for the transmission.

Responsive to the common DCI, the TX UE may be expected to send the single SCI as an SCI comprising at least two stages. That is, the PSCCH for one transmission may be split into two SCIs. Those SCIs may be a first and a second stage SCI, wherein those are either frequency multiplexed (FDMed) or time multiplexed (TDMed).

Idea 1.4—Parameters for Separate DCI Formats

Apart from the common parameters discussed above, embodiments propose that the DCI format for HARQ-based transmissions would contain parameters indicating the resources to be used in PUCCH, the time gap between the DCI and the PUCCH, and the slot offset between DCI reception and the first sidelink transmission scheduled by DCI. The DCI for blind transmissions may not contain these parameters related to HARQ feedback. A separate indication for HARQ-based and blind transmissions is also not required in this case and can, thus, be omitted. A transceiver in accordance with such embodiments may be based on additional parameters that includes parameters indicating one or more of:
Resources to be used in the PUCCH,
A time gap between the DCI and the PUCCH,
A slot offset between the DCI reception and the first sidelink transmission scheduled by the DCI.

Idea 2: Enhancements for HARQ Reporting Procedure

Embodiments related to HARQ reporting for blind transmissions. Such embodiments may address problems that may arise in different scenarios. In one scenario, the base station has full control of all Mode 1 UEs and states explicitly whether HARQ is to be used or not for each of the transmissions. Furthermore, it uses the same DCI format for HARQ and HARQ-less/blind transmissions, as described in connection with other embodiments. However, different from the previous section, embodiments address to ensure correct reception also of these DCIs. Hence, embodiments propose that these are also protected using a DAI which is used for HARQ-based transmissions. However, in this case, it has to be specified what the UE reports for HARQ-less/blind transmission to the base station.

A transceiver in accordance with such embodiments may be implemented in view of that the DCI includes a downlink assignment index, DAI, the DAI including a counter DAI, cDAI, and a total DAI, tDAI. The counter DAI may be incremented in case the DCI is for a HARQ-based retransmission and in case the DCI is for a blind retransmission. The transceiver is configured to increment the counter DAI for a DCI indicating a blind retransmission causing a reporting from the TX UE for the HARQ-less or blind transmission.

According to an embodiment, such a transceiver may, in case the DCI for the HARQ-less or blind transmission is received correctly at the TX UE, be configured to receive from the TX UE an ACK in the specified PUCCH resource so as to signal the correct reception of the DCI. The transceiver may decide to not schedule a new resource for this transmission since correct reception is assumed. In case, the DCI for the HARQ-less or blind transmission is received incorrectly at the TX UE, the transceiver may be configured to receive from the TX UE a NACK in the specified PUCCH resource. The transceiver may schedule in this case a new grant for the same transmission.

In accordance with Idea 2, the transceiver may be configured to receive, from the TX UE, an ACK in case the TX UE determines that all allowable transmission and/or retransmissions for the packet are completed. Responsive to the ACK the transceiver may stop allocating further resources for a packet, independent from the feedback on the PSFCH. Alternatively or in addition, the transceiver may be configured to receive an explicit parameter indicating that all allowable transmissions and/or retransmission for the packet are complete, the explicit parameter causing the transceiver to stop allocating further resources for the packet, independent from the feedback on the PSFCH.

A user device in accordance with Idea 2 may be implemented accordingly. The control message may be the common DCI. The DCI may include a downlink assignment index DAI including cDAI to be incremented in case the DCI is for a HARQ-based retransmission and in case the DCI is for a blind retransmission. The TX UE is configured to send an ACK in the corresponding PUCCH resource to the base station in case a DCI for a HARQ-less or blind transmission is successfully received.

Such a user device may, in case unexpected traffic arrives before a certain time before the HARQ-ACK for a HARQ-less transmission is reported to the base station, and the TX UE needs more resources, to be configured to reuse the HARQ-ACK feedback for a blind retransmission as a scheduling request, SR, to signal the base station the need of more resources, e.g., by transmitting a NACK for the blind transmission in case more resources are required. This procedure may be applied, for example, if no SR field is present in the corresponding PUCCH resource.

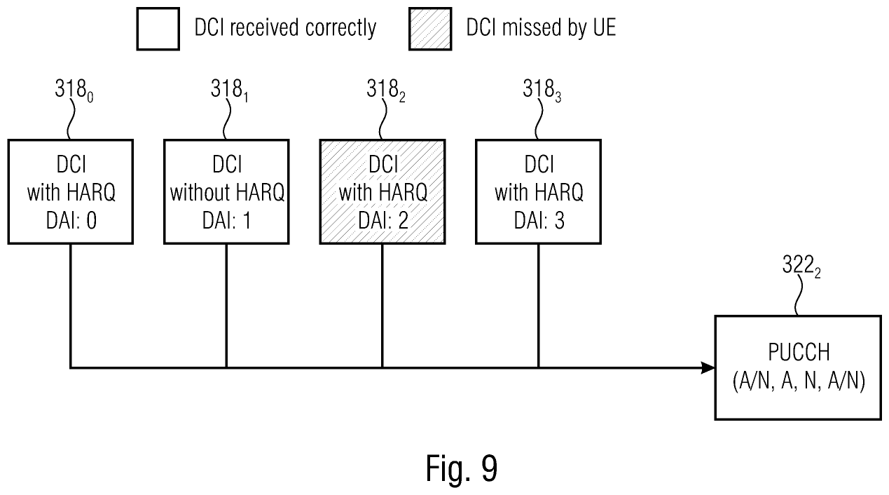

In other words, in another scenario, the base station may not specify explicitly in the DCI where the HARQ has to be used for a certain transmission or not, the UE may determine that autonomously based on QoS or it may be up to UE implementation to decide. However, in this case the base station has to specify a PUCCH resource for HARQ-ACK reporting since it would not know whether HARQ is used or not. Hence, feedback for HARQ-based and blind retransmissions may be multiplexed in the same PUCCH resource. Two different behaviors of the UE to determine the HARQ feedback for blind transmissions are described in connection with embodiments:
The TX UE could simply report an ACK for the HARQ-less/blind transmissions in the specified PUCCH resource to the base station in order to signal to the base station that no further resources are required for the given transmission, if the TX UE received a corresponding DCI correctly as shown, for example, in FIG. 9 showing a schematic diagram for a multiplexing of HARQ-based and blind/HARQ-less transmissions in a single PUCCH.
In case, the TX UE did not receive the DCI correctly, i.e., missed it, e.g., DCI 318₂, it would determine from the DAI (e.g., of DCI 318₃) that it missed a DCI and report a NACK regardless whether it was a HARQ-based or blind transmission as shown for feedback 322₂ related to DCI 318₂.
This enables the gNB to detect a missed DCI for a blind transmission and accordingly schedule a new grant for the same transmission.
In a different embodiment, unexpected traffic may have arrive before the HARQ-ACK for a HARQ-less transmission is reported to the base station and the UE needs more resources. In this case, UE may reuse the HARQ-ACK feedback for a blind transmission as a scheduling request, SR, to signal the base station the need of more resources. This is done by transmitting a NACK for the blind transmission in case more resources are required.
In a further embodiment, this procedure is only applied there is no SR field in the specified PUCCH resource.

Indication for Maximum Retransmissions

If the base station is not controlling each of the transmissions, it may not be able to track how many retransmissions already have been performed for a specific packet. In this case, the TX UE would again just report in the PUCCH what was transmitted by the RX UE in PSFCH to the base station. This may be a problem in case the RX UE reports again a NACK after all 32 retransmissions have been performed. Then, the base station would allocate a resource for a further retransmission without knowing that 32 re-transmissions already have been performed. This leads to resource wastage, since the UE may not have enough data to use this resource.

Hence, embodiments propose the following solutions:
1. The TX UE has certain knowledge on how many retransmissions it already performed for a certain TB or packet. In case the TX UE determines that all 32 retransmissions already have been performed, it reports in any case an ACK to the base station. Even, if the RX UE sends a NACK in the PSFCH. This way resource wastage can be reduced.
2. The RX UE has certain knowledge on how many retransmissions it already received for a certain TB or packet. In case the RX UE determines that all 32 retransmissions already have been performed, it reports in any case an ACK to the TX UE. Even, if it could not decode the TB or packet successfully. This way resource wastage can be reduced.
3. There can also be an explicit parameter indicating that all the 32 retransmissions are done, and if a NACK is sent by the RX UE to the TX UE, the base station can conclude that the packet cannot be successfully decoded.

Idea 3: Simultaneous Multiple HARQ-Based Transmissions

It is possible for the base station to schedule multiple DCIs corresponding to the HARQ-based transmission of different packets. Some of these DCIs could use slot aggregation to transmit larger packets, and at the same time, some DCIs could be used for packets that require only a single transmission (no retransmissions—one-shot transmissions).

According to an overall idea of the present embodiments, a user device (TX UE) for a wireless communication system is provided. The wireless communication system includes a plurality of user devices, UEs, to communication with each other using a sidelink, SL, wherein the user device is a transmitting user device, TX UE, served by a base station of the wireless communication system, and is to communicate with one or more receiving user devices RX UEs, using the sidelink. For a transmission of a packet, like a data packet, using the sidelink, the TX UE is to receive from the serving base station, dependent on one or more transition requirements for the transmission of the data packet, one or more control messages, like a DCI, the one or more control messages including:
Either a single common DCI including parameters for a HARQ-based transmission using the sidelink and for a blind or HARQ-free transmission using the sidelink, or,
Two different DCIs—one DCI for HARQ-based retransmissions including parameters for a HARQ-based transmission using the sidelink, and/or a DCI for HARQ-free retransmissions including parameters for a blind or HARQ-free transmission using the sidelink. Optionally, the serving base station may comprise or is a transceiver as described in connection with other embodiments.
That is, the transceiver may send one or more of
a common control message including parameters for a HARQ-based transmission using the sidelink and for a blind or HARQ-free transmission using the sidelink, or
a control message for HARQ-based retransmissions including parameters for a HARQ-based transmission using the sidelink, or
a control message for HARQ-free retransmissions including parameters for a blind or HARQ-free transmission using the sidelink.

According to an embodiment, the TX UE may be configured to receive from the base station one or more common DCIs indicating slot aggregation, and one or more DCIs for packets that require only a single transmission or one-shot transmission. In case the slot aggregation on the sidelink is active, the TX UE is configured to apply the same HARQ timeline for on the transmissions for which the TX UE has to send the HARQ-ACK to the base station. The PSSCH aggregation may be always active or may be activated by the base station using RRC or DCI signaling, the HARQ timeline being the maximum slot aggregation which is configured or activated for all transmissions. The HARQ timeline may be understood as the time taken from the time the DCI is received by the TX UE to the time the TX UE is ready to send a feedback to the base station, after it has received and decoded the transmission.

In other words, since the UE is communicating with multiple UEs in parallel and the slot aggregation scheme would be used only for a subset of the communication links, the timing of the HARQ reporting to the base station gets more complicated due to the different timing requirements of a one-shot transmission and a slot-aggregated transmission.

In Uu, the processing time is always applied from the end of the PDSCH or PUSCH to determine the earliest time of HARQ reporting. If the timeline is not met, the UE does not report back to the base station. However, in Uu the UE is configured with an aggregation factor (a certain K for K-repetition) and this parameter is applied globally to all transmissions and hence, there is no mismatch in case a UE misses a DCI. However, in SL, a mixed operation of slot-aggregated transmissions and one-shot transmissions is expected. This mainly causes an issue if the UE misses a DCI. In this case, it cannot know whether it was slot-aggregated transmission or one-shot transmission grant and cannot determine the processing timeline appropriately.

Single Processing Capabilities for SL HARQ

In case slot aggregation is activated for a TX UE, embodiments proposed to apply the same HARQ timeline for all the transmissions for which the TX UE has to send a HARQ-ACK to the base station. The PSSCH aggregation may be always active or activated by the base station using RRC or DCI signaling.

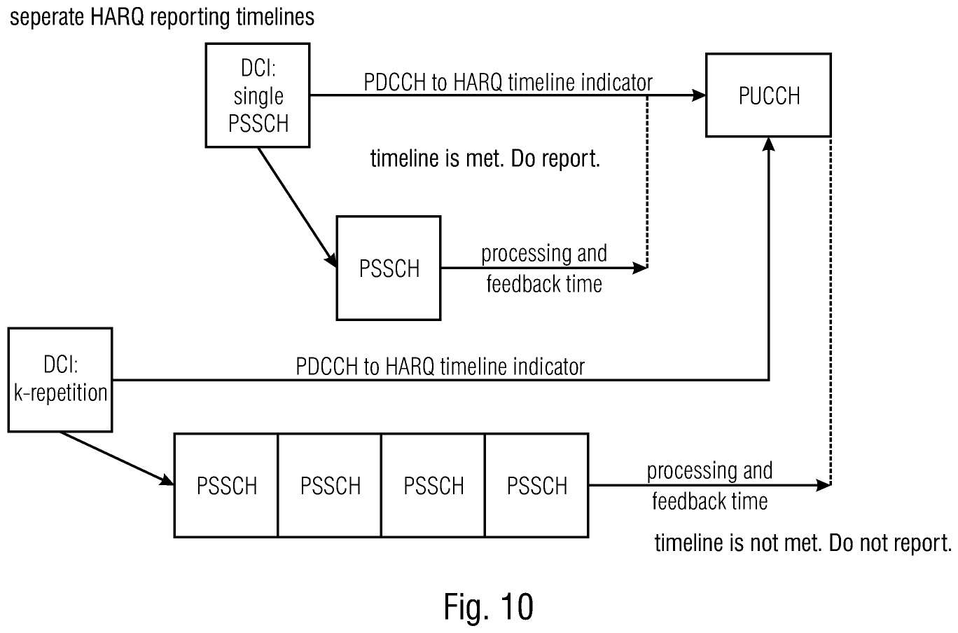

The DCI with a SL grant will specify the timing for the HARQ-ACK reporting, e.g., the slot in which the PUCCH is expected from the TX UE. However, the UE would not report an HARQ-ACK in the specified slot, if the HARQ timeline is not met, e.g., the specified slot is earlier than the HARQ timeline. According to an embodiment, the UE will apply to the HARQ timeline of the maximum slot aggregation which is configured/activated at the UE for all transmissions. Even, if the HARQ feedback for one-shot transmission is already available at the specified slot but the HARQ timeline for the maximum aggregation which is configured is not met, the UE will not report the HARQ-ACK in the specified PUCCH. This may be seen in FIG. 10 showing a schematic block diagram for illustrating separating processing of timelines.

In a further embodiment, the single processing capability may change up to configuration, e.g., whether the UE is configured with slot aggregation or not, or based on resource pool configurations (PSFCH periodicity).

Idea 4: Mode 1 HARQ Retransmissions Procedure and SCI Structures

According to an embodiment in accordance with Idea 4, a wireless communication system such as the one illustrated in FIG. 1 is adapted so as to comprise one or more base stations and a plurality of user devices, UEs, to communicate with each other using a sidelink, the plurality of UEs including a transmitting UE to communicate with one or more receiving UEs, using the sidelink. The base station is to serve the TX UE. For a transmission of a packet, like a data packet, using the sidelink, the base station is to determine one or more transmission requirement for the transmission of the data packet using the sidelink, and, responsive to the one or more determined transmission requirements, the base station is to send to the TX UE one or more control messages, the one or more control messages including one or more of:
A common control message including parameters for a HARQ-based transmission using the sidelink and for a blind or HARQ-free transmission using the sidelink, or
A control message for HARQ-based retransmissions including parameters for a HARQ-based transmission using the sidelink, or
A control message for HARQ-free retransmissions including parameters for a blind or HARQ-free transmission using the sidelink.

The TX UE may be configured to receive from the base station the one or more control messages, and is to transmit one or more control messages to the RX UE, and is to then further transmit the packet to the RX UE in accordance with the parameters indicated in the one or more control messages.

In accordance with Idea 4, the one or more base stations of the wireless communication system may be according to the further embodiments described herein. Alternatively or in addition, the plurality of user devices of the wireless communication system may be implemented as described in connection with the further embodiments described herein. The TX UE may be configured to receive from the base station the one or more control messages, and may be configured to transmit one or more control messages to the RX UE and is to then further transmit the packet to the RX UE in accordance with the parameters indicated in the one or more control messages.

In other words, the previous sections describe the possibility of sending a single or multiple DCIs containing retransmission resource locations, based on whether the TX UE sends SCIs to the RX UE. The RX UE is now expected to decode the transmission and decide whether it was successfully decoded or not. Based on this decision, the RX UE sends HARQ feedback to the TX UE.

Idea 4.1—Periodicity of HARQ Feedback Sent from RX UE to TX UE

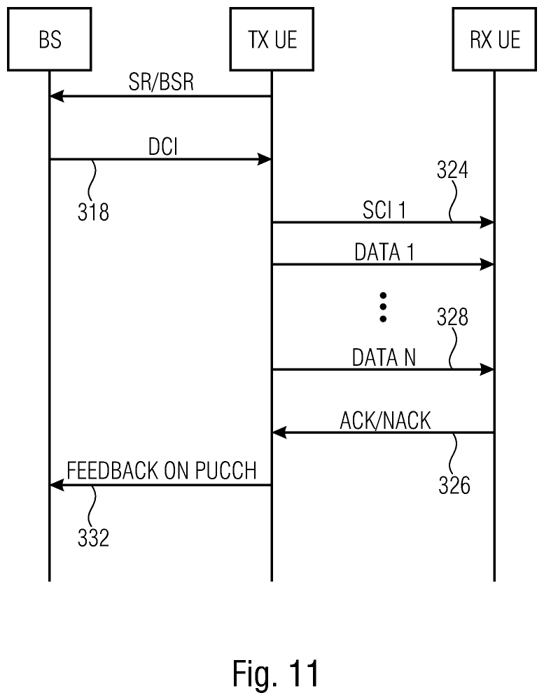

According to an embodiment being described in connection with FIG. 11, the base station of a wireless communication system in accordance with embodiments may be configured to send to the TX UE a single DCI 318 indicating a HARQ-based transmission, transmission and/or retransmission resource locations and a single PUCCH location. The TX UE may be configured to send, to the RX UE, a single SCI 324. The RX UE may be configured to send, to the TX UE, a single HARQ feedback 326, wherein the RX UE may be configured to combine all the received retransmissions 328, and to send a HARQ feedback only after successfully decoding the packets or after the maximum number of retransmissions. The TX UE is to relay to the base station a single HARQ feedback 332 using the single PUCCH resource defined in the single DCI 318.

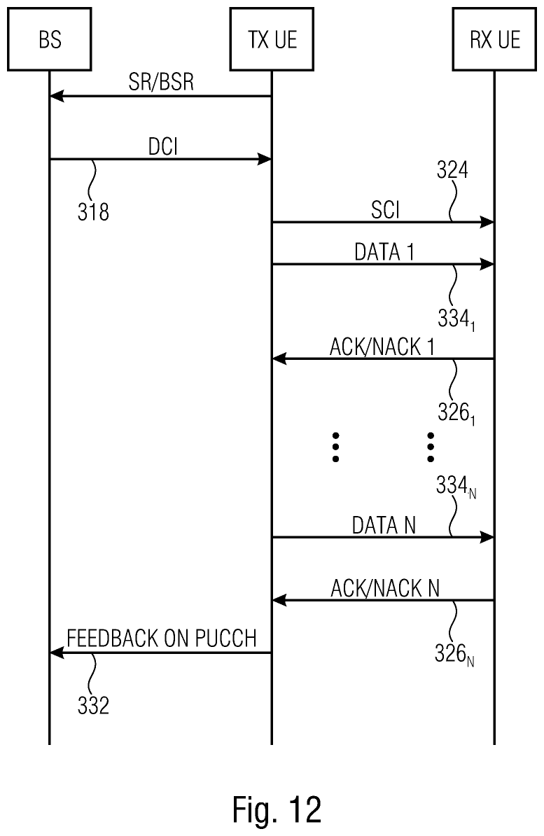

According to an embodiment which is illustrated in connection with FIG. 12, the wireless communication system described herein is implemented such that the base station is configured to send, to the TX UE the single DCI 318 being explained in connection with FIG. 11, indicating a HARQ-based transmission and including a single PUCCH location for the transmission and/or retransmission resource locations. The TX UE is configured to send to the RX UE the single SCI 324 of FIG. 11. The TX UE is configured to receive multiple HARQ feedbacks 326₁ to 326_{N} from the RX UE, but informs the base station only when the RX UE successfully decodes the packet. The TX UE is to stop sending retransmissions once the RX UE has responded with a positive HARQ. That is, after a feedback 326 from the RX UE being interpreted as a positive ACK, further data signals 334 may be omitted.

The TX UE may schedule a CBG (code block group)—based transmission including, e.g., several code blocks which are grouped in the CBGs, to the RX UE using a single SCI, so as to expect multiple feedbacks, e.g., one pair each CBG.

In other words, according to an embodiment being proposed in connection with FIG. 11, the process of sending the HARQ feedback can be defined as single DCI sent from BS to TX UE, followed by which a single SCI is sent from TX UE to RX UE, which in turn provides a single HARQ feedback from RX UE to TX UE
The RX UE will combine all the received retransmissions, and will send a HARQ feedback only after either successfully decoding the packets, or after the maximum number of retransmissions
   This is then related to the base station by the TX UE using the single PUCCH resource defined in the single DCI 318.

According to an embodiment being described in connection with FIG. 12 and that may be referred to as single DCI, single SCI and multiple HARQ feedback per transmission,
The TX UE receives multiple HARQ feedbacks 326₁ to 326_{N} from the RX UE, but with informed base station only when the RX UE successfully decodes the packet.
The TX UE may schedule a CBG-based transmission, i.e., including several code blocks which are grouped in CBGs, code block groups, through the RX UE using a single SCI 324
   In this case, the TX UE expects multiple feedbacks, i.e., one per each CBG.

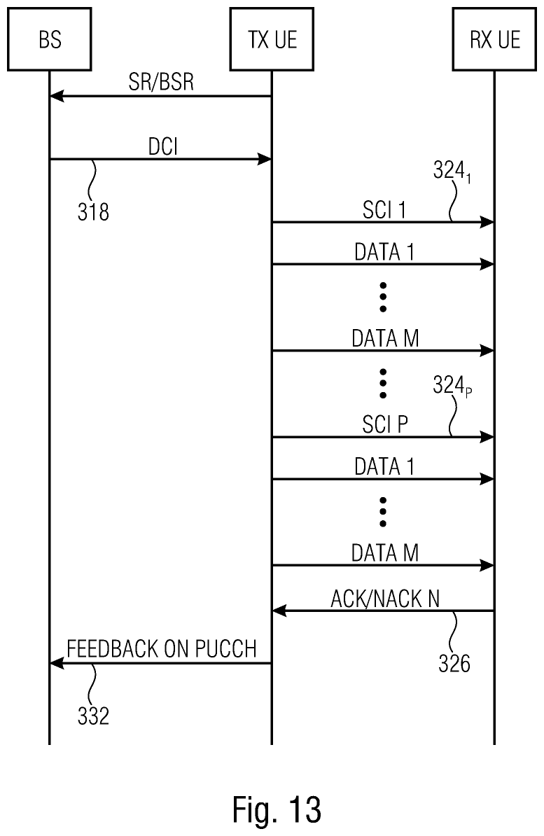

According to an embodiment which may be referred to as single DCI, multiple SCIs and single HARQ feedback which is illustrated in FIG. 13, the wireless communication system is implemented such that the base station is configured to send to the TX UE a single DCI indicating a HARQ-based transmission and including a single PUCCH location for the transmission and/or retransmission resource locations. The TX UE is configured to send, to the RX UE, multiple SCIs with retransmission resource locations in each SCI. The RX UE is configured to combine all the received retransmissions and is to send a HARQ feedback only after successfully decoding the packets, or after the maximum number of retransmissions, or after a configured or pre-configured number of retransmissions. The TX UE is configured to relate to the base station a single HARQ feedback using the single PUCCH resource defined in the single DCI.

In other words:
The TX UE will send multiple SCIs 324 with retransmission resource locations in each of the;
The RX UE will combine all the received retransmissions and will send a HARQ feedback 326 only after either successfully decoding the packets, or after the maximum number of retransmissions, or after a configured or pre-configured number of retransmissions.
This is then related to the base station by the TX UE using the single PUCCH resource defined in the single DCI.

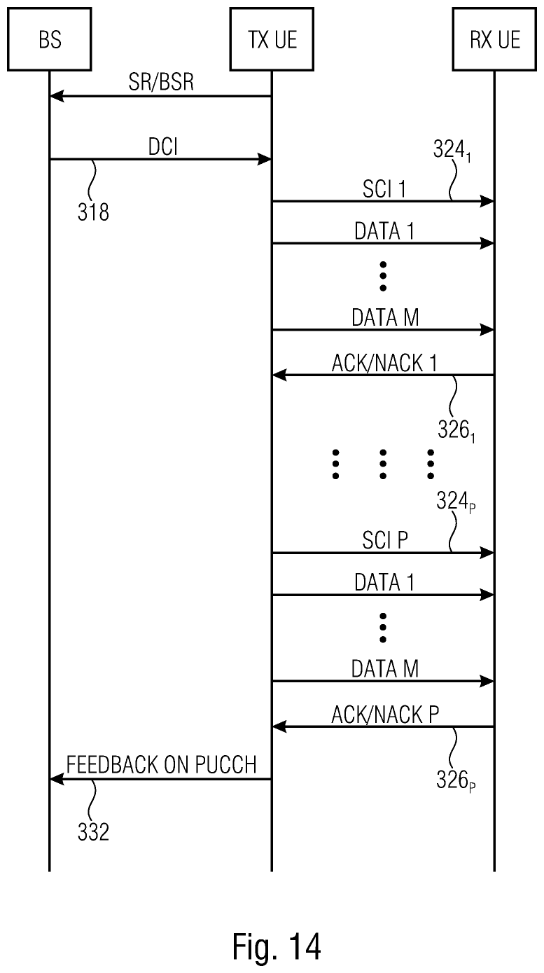

According to an embodiment which is described in connection with FIG. 14, the wireless communication system is implemented such that the base station is configured to send to the TX UE a single DCI 318 indicating a HARQ-transmission and including a single PUCCH location for the transmission and/or retransmission resource locations. The TX UE is to send multiple SCIs 324 with retransmission resource locations in each of the SCIs. The RX UE is configured to combine the received transmissions defined in a given SCI and is configured to send an HARQ feedback based on the transmissions defined in that SCI, i.e., up to P HARQ feedbacks. The TX UE is to receive the feedback per SCI and is configured to stop sending SCIs once there are RX UE has responded with a positive ACK in one of the feedbacks 326. The TX UE is to relay, to the base station, a single HARQ feedback 332 using the single PUCCH resource defined in the single DCI 318.

In other words, FIG. 14 shows a scenario that may be named single DCI, multiple SCIs and multiple HARQ feedback per SCI in which:
The TX UE will send multiple SCIs with retransmission resource locations in each of them
The RX UE will combine the received transmissions defined in a given SCI and will send a HARQ feedback based on the transmissions defined in that SCI.
The TX UE will receive the feedback per SCI, and will stop sending SCIs once the RX UE has responded with a positive ACK
This is then related to the base station by the TX UE using the single PUCCH resource defined in the single DCI.

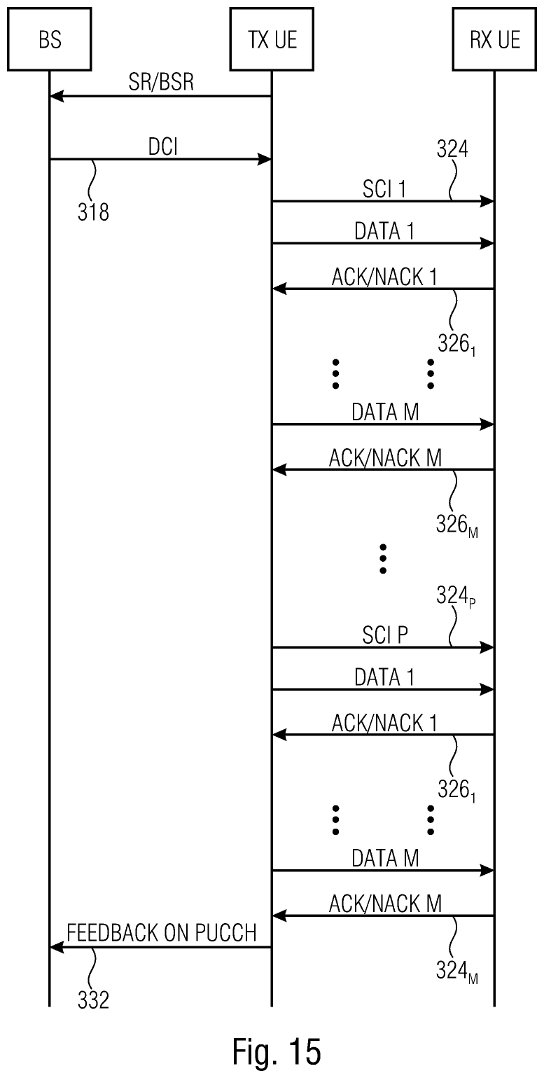

According to an embodiment being illustrated in connection with FIG. 15 which may be referred to as single DCI, multiple SCIs and multiple HARQ feedback per retransmission, the base station of the wireless communication system is configured to send, to the TX UE, a single DCI 318 indicating a HARQ-based transmission and including a single PUCCH location for the transmission and/or retransmission resource locations. The TX UE is configured to send multiple SCIs 324 with retransmission resource locations in each of the SCIs. The RX UE is configured to send a HARQ feedback for each of the transmissions. The TX UE is configured to receive all the feedback and is configured to stop sending retransmissions and further SCIs once the RX UE has responded with a positive ACK, i.e., when one of the messages 326 contains a positive feedback. The TX UE is configured to relay, to the base station, a single HARQ feedback using the single PUCCH resource defined in the single DCI.

In other words, according to the embodiment:
The TX UE will send multiple SCIs with retransmission resource locations in each of them
The RX UE will send a HARQ feedback for each of the transmissions
The TX UE will receive all the feedback and will stop sending SCIs once the RX UE has responded with a positive ACK
This is then related to the base station by the TX UE using the single PUCCH resource defined in the single DCI.

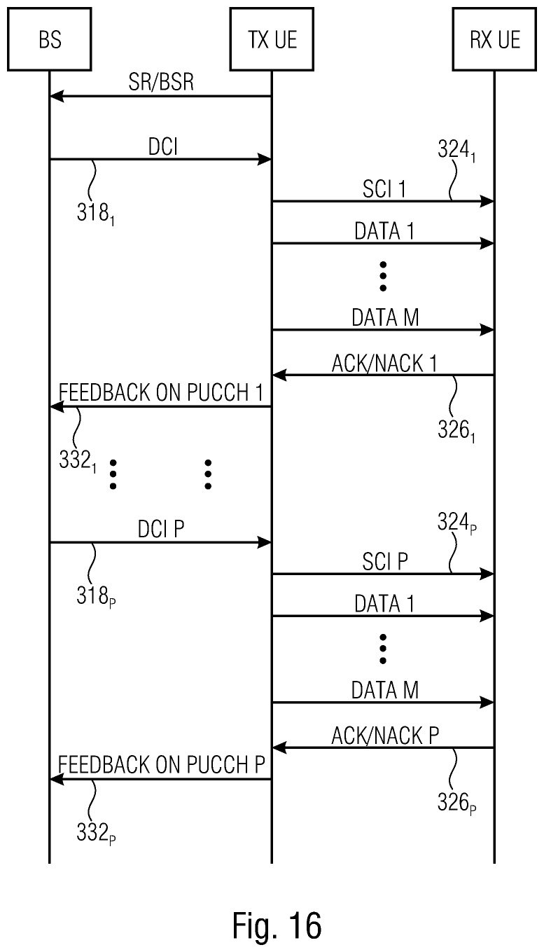

According to an embodiment being described in connection with FIG. 16 and that may be referred to as multiple DCIs, multiple SCI (for each DCI), multiple HARQ feedback per SCI, the wireless communication system is implemented such that the base station is configured to send, to the TX UE, multiple DCIs indicating a HARQ-based transmission, each including a single PUCCH location for the transmission and/or retransmission resource locations. The TX UE is configured to send multiple SCIs with retransmission resource location in each of the SCIs. The RX UE is configured to combine the received transmissions defined in a given SCI, and is configured to send a HARQ feedback based on the transmissions defined in that SCI. the TX UE is configured to receive the feedback per SCI, and is to relate to the base station the feedback using the PUCCH resource defined in the corresponding DCI. For receiving a feedback indicating a successful decoding of the packet by the RX UE, the base station is configured to stop sending DCIs to the TX UE for the said packet.

In other words, the embodiment comprises:
The base station sends multiple DCIs, with each DCI containing retransmission resource locations which are then sent by the TX UE to the RX UE by SCIs
The RX UE will combine the received transmission defined in a given SCI and will send a HARQ feedback based on the transmissions defined in that SCI
The TX UE will receive the feedback per SCI, and is then related to the base station using the PUCCH resource defined in the corresponding DCI
Once the RX UE successfully decodes the packet, and it is relayed back to the base station, it will stop sending DCIs to the TX UE for the said packet.

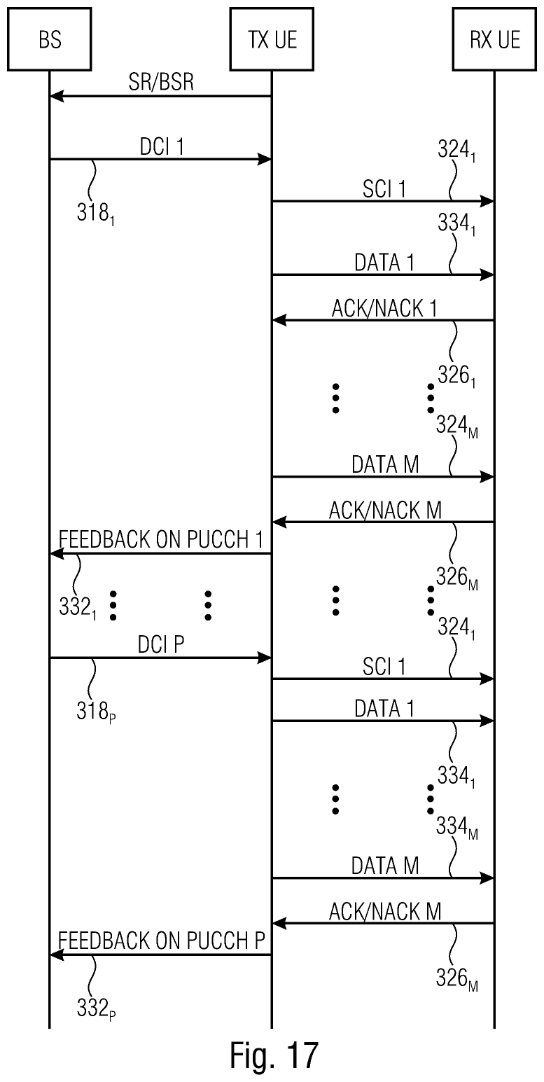

According to an embodiment which is described in connection with FIG. 17 and which may be referred to as multiple DCIs, multiple SCI (for each DCI), multiple HARQ feedback per retransmission, the wireless communication system is implemented such that the base station is configured to send to the TX UE multiple DCIs indicating a HARQ-based transmission, each including a single PUCCH location for the transmission and/or retransmission resource locations. The TX UE is configured to send multiple SCIs with retransmission resource locations in each of the SCIs. The RX UE is to send a HARQ feedback for each of the transmissions. The TX UE is configured to receive all the feedback, and to relay to the base station the feedback using the PUCCH resource defined in the corresponding DCI. The TX UE is configured to stop SCIs once the RX UE has responded with a positive ACK, and wherein, responsive to the positive feedback, the base station is to stop sending DCIs to the TX UE for the said packet.

In other words, the embodiment may be explained as:
The base station sends multiple DCIs, with each DCI containing retransmission resource locations which are then sent by the TX UE to the RX UE by SCIs
The RX UE will send a HARQ feedback for each of the transmissions
The TX UE will receive all the feedback, and is then relayed to the base station using the PUCCH resource defined in the corresponding DCI
The TX UE will stop sending SCIs once the RX UE has responded with a positive ACK, and it is relayed back to the base station, which will stop sending DCIs to the TX UE for the said packet.

In case the DCI provides a resource allocation for the initial transmission and further retransmissions with each having a feedback channel, e.g., PUCCH, then transmitted an ACK for one of these transmissions from the TX UE to the GNB invalidates subsequent resource allocations. For example, if the DCI schedules four transmission locations distributed in time, the TX UE may first use the first resource allocation in time to perform an initial transmission. Assuming that the RX UE answers with a NACK, the TX UE will report an ACK to the GNB and will use the next resource in time to perform a retransmission. If then the RX UE reports ACK, then the TX UE reports the ACK to the GNB and does not use the subsequent two resources, which were foreseen for possible retransmissions. This can be rescheduled by the GNB to the same or another SL UE.

Idea 4.2—SCI Structure

In accordance with embodiments, the wireless communication system may be implemented such that, based on the information provided to the TX UE on a DCI by the base station, the resources are defined in the SCI by one or more of the following:
In case the frequency location or sub channel of the initial transmission and the one or more retransmissions are the same, the resources are defined by at least one of
   A bit map indicating the time slots in which the retransmissions occur, e.g., in the form of a factor or in the form of an index mapped to a table in the RX UE containing multiple bit map factors,
   A timing offset, where the receiving UE can then derive the time slots in which the retransmission occurs;
The frequency locations or sub channels of the initial transmission and the one or more retransmissions are different, the resources are defined by a time-frequency pattern indicating the time and frequency locations of the resources, e.g., in the form of an index mapped to a table in the RX UE containing multiple time-frequency patterns,
Slot aggregation parameter indicating the number of aggregated slots,
DAI parameters.

Idea 5: Mode 2: Blind and HARQ Retransmissions-Procedure

To further specify the transceiver according to the general idea, according to an embodiment, the transceiver may be implemented as a transmitting UE communicating with one or more receiving UEs, using the sidelink. The transmitted and/or receiving UEs may be operating in NR Mode 2. The one or more control messages are sidelink control information messages (SCI messages) comprising sidelink control information, SCI.

In other words, in Mode 2, the TX UE is responsible for making decisions regarding the following aspects:
Whether the packet requires HARQ feedback or blind retransmissions (based on reliability requirements)
   QoS, channel conditions, etcetera.
Number of retransmissions for either scheme above (based on PDB requirements)
Resources to be used for (re)transmissions by TX UE (based on availability of resources)

The TX UE receives high layer information regarding the packet which would provide parameters such as the priority, PDB and permissible Packet Error Rate (PER) (relates to the reliability attached to the packet). Embodiments propose that the TX UE uses this higher layer information into consideration in order to make the above-mentioned decisions. The congestion situation of the resources at a given point in time also has to be taken into consideration, based on the sensing results of the TX UE. The TX UE may send the priority attached to the packet on the SCI so that the RX UE can align itself accordingly.

Idea 6: Configured Grants

According to an embodiment, the wireless communication system described herein may be implemented such that it uses configured grants. When using configured grants, in case some grants contain information regarding the PUCCH and some do not contain information regarding the PUCCH, the TX UE may be configured to
Use that the grants that contain PUCCH resources to send feedback back to the base station, and
Use the grants that contain no PUCCH resources for blind transmissions.

According to an embodiment, such a wireless communication system may be configured, for when using configured grants, the TX UE is configured to decide on which grant to transmit the packet dependent on the characteristics of the grant, e.g., dependent on a quality of the resources, the TX UE may use a grant for packets requiring a high or low priority and/or reliability and/or latency.

Such a wireless communication system may be implemented that, when using configured grants, the TX UE is to decide on which grant to transmit the packet dependent on the communication type, e.g., dependent on a condition of the resources, the TX UE may use a grant for packets related to broadcast, groupcast or unicast transmissions.

In other words, in configured grants, some grants can contain information regarding the PUCCH and some need not. The ones that contain PUCCH resources will be used by the TX UE to send feedback back to the base station. The grants without them can be used for blind transmissions. Since multiple configured grants can be provided by the base station to the TX UE, and the TX UE can use any of these grants to transmit a TB, the UE decides on which grant to use based on the characteristics of the grant. These characteristics include the quality of the resources, based on which the TX UE can use them for high/low priority, reliability, and latency cases, as well as the cast type (broadcast, groupcast and unicast).

### GENERAL

Embodiments of the present invention have been described in detail above, and the respective embodiments and aspects may be implemented individually or two or more of the embodiments or aspects may be implemented in combination.

With regard to the above-described embodiments of the various aspects of the present invention, it is noted that they have been described in an environment in which a communication is between a transmitter, like a TX UE, and a receiver, like a RX UE, in a V2X scenario. However, the invention is not limited to such a communication, rather, the above-described principles may equally be applied for any device-to-device communication over the sidelink, like a D2D, V2V communication.

Embodiments described herein may thus be implemented in wireless communication systems, for example, in vehicular communication systems, e.g., V2X, as in the context of cellular (e.g., 3G, 4G, 5G or future), or ad hoc communication networks. Embodiments focus on the optimum procedure for the base station (in Mode 1) or the TX UE (in Mode 2) to transmit the control information regarding the resources to be used for the (re)transmissions of the packet as well as the resources to be used for transmitting the feedback.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, the user device, UE, may be one or more of a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity. The base station, BS, may be implemented as mobile or immobile base station and may be one or more of a macro cell base station, or a small cell base station, or a central unit of a base station, or a distributed unit of a base station, or a road side unit, or a UE, or a group leader (GL), or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

In the following, additional embodiments and aspects of the invention will be described which can be used individually or in combination with any of the features and functionalities and details described herein.

A first aspect relates to a transceiver for a wireless communication system, the wireless communication system including a plurality of user devices, UEs, to communicate with each other using a sidelink, SL, wherein

for a transmission of a packet, like a data packet, using the sidelink, the transceiver is to determine one or more transmission requirements for the transmission of the data packet using the sidelink,

responsive to the one or more determined transmission requirements, the transceiver is to send one or more control messages, the one or more control messages including one or more of:
a common control message including parameters for a HARQ-based transmission using the sidelink and for a blind or HARQ-free transmission using the sidelink, or
a control message for HARQ-based retransmissions including parameters for a HARQ-based transmission using the sidelink, or
a control message for HARQ-free retransmissions including parameters for a blind or HARQ-free transmission using the sidelink.

According to a second aspect when referring back to the first aspect, the one or more transmission requirements may have one or more of:
whether the packet requires HARQ feedback or blind retransmissions, e.g., based on reliability requirements, like QoS or channel conditions,
a number of retransmissions for the HARQ feedback scheme and/or for the blind retransmissions scheme, e.g., based on the Packet Delay Budget, PDB, requirements,
resources to be used for the transmission and the retransmissions using the sidelink, e.g., based on an availability of resources, like a congestion situation of the resources.

According to a third aspect when referring back to the first or second aspect, the transceiver is to determine the one or more transmission requirements responsive to higher layer information regarding the packet, like the priority, PDB or permissible Packet Error Rate (PER) (relates to the reliability attached to the packet).

According to a fourth aspect when referring back to any of the first to third aspects, the transceiver may be a base station of the wireless communication system communicating with a transmitting UE, TX UE, using the Uu link, the TX UE communicating with one or more receiving UEs, RX UEs, using the sidelink, the transmitting and/or receiving UEs being in NR Mode 1.

According to a fifth aspect when referring back to the fourth aspect, the base station is to transmit to the TX UE one or more control messages using one or more of:
dynamic grants, where the base station sends a DCI to the TX UE,
configured grants type 1, where the base station configures resources for the TX UE via RRC signaling,
configured grants type 2, where the base station configures resources for the TX UE via RRC signaling, and a DCI is sent in order to activate/deactivate the grant.

According to a sixth aspect when referring back to the fourth or fifth aspect, each of the one or more control messages may have common control message parameters, the common control message parameters including one or more of:
a resource location indication,
a slot aggregation indication,
a total number of retransmissions,
an MCS level,
a maximum TX power,
a destination ID,
a cast type,
transmission procedure indicator e.g. blind-transmission or retransmission, or HARQ enabled transmission,
a priority indication.

According to a seventh aspect when referring back to the sixth aspect, for a given maximum or allowable number of transmissions and/or retransmissions, e.g., 32 retransmissions in NR SL, the resource location indication may have time and frequency locations of the transmissions and/or one or more retransmissions,

wherein, in case the frequency location or subchannel of the initial transmission and the one or more retransmissions are the same, the resource location indication includes at least one of:
a bitmap indicating the time slots in which the retransmissions occur, e.g., in the form of a vector or in the form of an index mapped to a table in the TX UE containing multiple bitmap vectors,
a timing offset, which can de indicated in the DCI or in the RRC configuration, wherein the RX UE can then derive the time slots in which the retransmissions occur, until the total number of retransmissions possible is reached.

wherein, in case the frequency locations or subchannels of the initial transmission and the one or more retransmissions are different, the resource location indication includes a time-frequency pattern indicating the time and frequency locations of the resources, e.g., in the form of an index mapped to a table in the TX UE containing multiple time-frequency patterns.

According to an eighth aspect when referring back to the sixth or seventh aspect, the TX UE may be configured with a parameter, like a PSSCH-Aggregation Factor parameter, using, for example, RRC signalling, the parameter indicating a number of slots to be aggregated, e.g., for a large packet using multiple PSSCH regions across slots for the transmission of the packet, and

the slot aggregation indication indicates only the frequency or subchannel and the starting point of the first slot to be used.

According to a ninth aspect when referring back to the eighth aspect, a time offset between each of the aggregated slots may be pre-configured or configured using semi-static signalling, such as RRC.

According to a tenth aspect when referring back to any of the fourth to ninth aspects, the control messages is the common control message, having one or more of:
a retransmission type indication indicating whether the one or more retransmissions over the sidelink are HARQ-based retransmissions or blind retransmissions,
a Downlink Assignment Index, DAI,
a retransmission feedback resource location indication indicating the resource locations for transmitting a feedback from the TX UE to the base station, e.g., on the PUCCH.

According to an eleventh aspect when referring back to the ninth aspect, the retransmission type indication may be
explicit and includes an explicit parameter indicating whether the packet to be transmitted uses HARQ-based retransmissions or blind retransmissions, or
is implicit by setting one or more certain parameters in the DCI to a predefined or default value

According to a twelfth aspect when referring back to the tenth aspect, in case of an implicit retransmission type indication, the use of blind retransmissions may be indicated by
using a non-numerical value or a default or pre-configured value for parameters indicating the resources to be used for a feedback from the TX UE to the base station, e.g., in the PUCCH, like a PUCCH resource indicator, or a time gap between the DCI and the feedback, e.g. on the PUCCH, like a PSSCH/PDCCH-to-HARQ-timing indicator, or
a resource location indication for the transmissions and/or retransmissions which points to a set of resources or to a resource pool not including any resources for a PSFCH, and/or

the use of HARQ-based retransmissions is indicated by
a resource location indication for the transmissions and/or retransmissions which points to a set of resources or to a resource pool including resources for a PSFCH;

and/or the use of the destination ID, priority information or cast type e.g. transmission resources for broadcast or a destination ID that has no HARQ configured.

According to a thirteenth aspect when referring back to any of the tenth to twelfth aspects, the DCI may have a downlink assignment index, DAI, the DAI includes a counter DAI, cDAI, and a total DAI, tDAI, and

in case the DCI is for blind retransmissions using the sidelink
the counter DAI is not incremented or a default or pre-configured value, like −1, is assigned the counter DAI, and/or
the DCI is not counted in the total DAI, and/or
the TX UE is to ignore the counter DAI, and/or
the counter DAI is incremented, but the counter DAI of a following DCI for HARQ-based retransmissions is not incremented.

According to a fourteenth aspect when referring back to any of the tenth to twelfth aspects, the DCI may have a downlink assignment index, DAI, the DAI includes a counter DAI, cDAI, and a total DAI, tDAI, and

the counter DAI is incremented in case the DCI is for a HARQ-based retransmission and in case the DCI is for a blind retransmission, wherein the transceiver is to increment the counter DAI for a DCI indicating a blind or HARQ-less transmission and/or retransmission causing a reporting from the TX UE for the HARQ-less or blind transmission.

According to a fifteenth aspect when referring back to the thirteenth aspect, in case the DCI for the HARQ-less or blind transmission is received correctly at the TX UE, the transceiver is to receive from the TX UE an ACK in the specified PUCCH resource so as to signal that no further resources are required for the given transmission, and to increment the counter DAI, and

in case the DCI for the HARQ-less or blind transmission is received incorrectly at the TX UE, the transceiver is to receive from the TX UE a NACK in the specified PUCCH resource.

According to a sixteenth aspect when referring back to any of the tenth to fifteenth aspects, in case of blind and HARQ-based retransmissions, the transmission and/or retransmission location indication in a DCI indicates some or all transmission and/or retransmission locations, and

in case of HARQ-based retransmissions alone, the retransmission location indication in a DCI to be send to the TX UE indicates a PUCCH resource on which the TX UE may forward a HARQ feedback the TX UE receives from the RX UE to the base station.

According to a seventeenth aspect when referring back to the sixteenth aspect, in case of HARQ-based retransmissions, the retransmission location indication in a DCI indicates a number of transmission and/or retransmission resource locations, the number of transmission and/or retransmission resource locations is MxP, where MxP does not exceed the maximum or allowable number of transmissions and/or retransmissions, e.g., 32 retransmissions in NR, for a packet, where M is the number of transmission and/or retransmission resource locations contained in a single DCI, where P is the number of DCIs sent for the given packet.

According to an eighteenth aspect when referring back to the seventeenth aspect, the DCI contains a single PUCCH location for M transmission and/or retransmission resource locations, and the transceiver is to
send a DCI, the DCI containing M transmission and/or retransmission resource locations and only one PUCCH location,
receive, responsive to the DCI, from the TX UE a combined feedback of the RX UE for all the M transmissions by using the single PUCCH location,
repeat sending a DCI P times until the feedback indicates a successful decoding of the packet at the RX UE, or until a maximum number, MxP, of retransmissions is reached.

According to a nineteenth aspect when referring back to the seventeenth aspect, the DCI contains multiple PUCCH locations for each of the transmission and/or retransmission resource locations, and the transceiver is to
send a DCI, the DCI containing M transmission and/or retransmission resource locations and a PUCCH location for each transmission and/or retransmission resource location,
receive, responsive to the DCI, from the TX UE a feedback of the RX UE for each of the M transmissions by using the PUCCH location for the transmission and/or retransmission,
repeat sending a DCI P times until the feedback indicates a successful decoding of the packet at the RX UE, or until a maximum number, MxP, of retransmissions is reached.

According to a twentieth aspect when referring back to the seventeenth aspect, the DCI contains multiple PUCCH locations for a multiple of the transmission and/or retransmission resource locations, and the transceiver is to
send a DCI, the DCI containing MxP transmission and/or retransmission resource locations and a PUCCH location after each M^{th} transmission and/or retransmission resource location,
receive, responsive to the DCI, from the TX UE a feedback of the RX UE after each M^{th} transmissions by using the PUCCH location for the transmission and/or retransmission,
continue to receive feedback from the TX UE after every M transmissions until the feedback indicates a successful decoding of the packet at the RX UE, or until a maximum number, MxP, of retransmissions is reached.

According to a twenty-first aspect when referring back to the nineteenth or twentieth aspect, the DCI is to indicate explicitly or implicitly,

wherein, in case of an explicit indication, the DCI contains all the PUCCH locations for the transmissions and/or retransmissions,

wherein, in case of an implicit indication, the DCI contains the PUCCH resource location corresponding to a first transmission, and for subsequent transmissions and/or retransmissions the TX UE is to derive the PUCCH locations for subsequent transmissions and/or retransmissions using at least one of
a time gap between the resource locations for the subsequent transmissions and/or retransmissions, and applying the given time gap with the PUCCH resource location for the first transmission as the starting point, or
a time gap between the initial transmission location and the PUCCH resource location, and applying the given time gap for the subsequent retransmission resource locations.

According to a twenty-second aspect when referring back to the nineteenth or twentieth aspect, the DCI is to indicate explicitly or implicitly,

wherein the transceiver is to indicate in the first DCI
a HARQ-timing indicator which points to a slot where the first HARQ-feedback is to be reported, and
a PUCCH resource indicator, PRI, which indicates one out of multiple configured PUCCH configurations to use for PUCCH transmission within the slot, and

wherein one or more slots for a subsequent HARQ-feedback are determined by applying the same offset to the PUCCH resources which is also applied to the PSSCH transmissions.

According to a twenty-third aspect when referring back to any of the tenth to twenty-second aspects, the transceiver is to
receive from the TX UE an ACK in case the TX UE determines that all allowable transmissions and/or retransmissions for the packet are completed or
receive an explicit parameter indicating that all allowable transmissions and/or retransmissions for the packet are completed.

According to a twenty-fourth aspect when referring back to the twenty-third aspect, the transceiver in response to the ACK or the explicit indication, indicating that the transmissions and/or retransmissions for the packet are complete, will stop allocating further resources for the packet, independent from the feedback on the PSFCH.

According to a twenty-fifth aspect when referring back to any of the fourth to ninth aspects, the control messages is the control message for HARQ-based retransmissions, the control message for HARQ-based retransmissions including parameters indicating one or more of:
resources to be used in the PUCCH,
a time gap between the DCI and the PUCCH,
a slot offset between the DCI reception and the first sidelink transmission scheduled by the DCI.

According to a twenty-sixth aspect when referring back to any of the first to third aspects, the transceiver is a transmitting UE, TX UE, communicating with one or more receiving UEs, RX UEs, using the sidelink, the transmitting and/or receiving UEs being in NR Mode 2, and the one or more control messages are sidelink control information, SCI, messages comprising sidelink control information, SCI.

According to a twenty-seventh aspect when referring back to the fourth aspect, the one or more transmission requirements further include one or more of:
resources to be used in the PUCCH for the TX UE to provide feedback to the base station in case of HARQ-based transmission using the sidelink,
a time gap between a PDCCH transmission containing the DCI to the TX UE and the PUCCH transmission containing the feedback from the TX UE to the base station,
a slot offset between DCI reception and a first sidelink transmission scheduled by the DCI.

A twenty-eighth aspect relates to a user device for a wireless communication system, the wireless communication system including a plurality of user devices, UEs, to communicate with each other using a sidelink, SL, wherein

the user device is a transmitting user device, TX UE, served by a base station of the wireless communication system, and is to communicate with one or more receiving user devices, RX UEs, using the sidelink, and

for a transmission of a packet, like a data packet, using the sidelink, the TX UE is to receive from the serving base station, dependent on one or more transmission requirements for the transmission of the data packet, one or more control messages, like a DCI, the one or more control messages including one or more of:
common DCI including parameters for a HARQ-based transmission using the sidelink and for a blind or HARQ-free transmission using the sidelink, or
DCI for HARQ-based retransmissions including parameters for a HARQ-based transmission using the sidelink, or
DCI for HARQ-free retransmissions including parameters for a blind or HARQ-free transmission using the sidelink.

According to a twenty-ninth aspect when referring back to the twenty-eighth aspect, the serving base station comprises or is a transceiver according to any one of the first to twenty-seventh aspects.

According to a thirtieth aspect when referring back to the twenty-eighth or twenty-ninth aspect, the control messages is the common DCI, wherein, responsive to the common DCI, the TX UE is expected to send at least one of the following:
a single SCI with all the resource locations, with an indication that the feedback for each of the transmissions has to be sent, or
multiple SCIs containing a further subset of the resource locations described in the DCI, and specify that feedback has to be sent for each of the transmissions, and

wherein TX UE, on receiving the feedback from the RX UE per transmission, will provide the feedback to the base station on the PUCCH resources, which are either implicitly derived or explicitly indicated in the DCI, for the transmission.

According to a thirty-first aspect when referring back to the thirtieth aspect, the control messages is the common DCI,

wherein, responsive to the common DCI, the TX UE is expected to send the single SCI as an SCI comprising at least two stages.

According to a thirty-second aspect when referring back to any of the twenty-eighth to thirty-first aspects, the control messages is the common DCI,

the DCI includes a downlink assignment index, DAI, the DAI includes a counter DAI, cDAI, to be incremented in case the DCI is for a HARQ-based retransmission and in case the DCI is for a blind retransmission is successfully received at the TX UE,

wherein the TX UE is to send an ACK to the base station in case a DCI for a HARQ-less or blind transmission is successfully received, to cause the base station to increment the counter DAI for the DCI indicating a blind retransmission.

According to a thirty-third aspect when referring back to thirty-second aspect, in case unexpected traffic arrives before the HARQ-ACK for a HARQ-less transmission is reported to the base station, and the TX UE needs more resources, the TX UE is to reuse the HARQ-ACK feedback for a blind transmission as a Scheduling Request, SR, to signal the base station the need of more resources, e.g., by transmitting a NACK for the blind transmission in case more resources are required.

According to a thirty-fourth aspect when referring back to any of the twenty-eighth to thirty-third aspects, the TX UE is to receive from the base station one or more common DCIs indicating slot aggregation, and one or more DCIs for packets that require only a single transmission or one-shot transmission,

in case the slot aggregation on the sidelink is active, the TX UE is to apply the same HARQ timeline for all the transmissions for which the TX UE has to send a HARQ-ACK to the base station, wherein the PSSCH aggregation may be always active or may be activated by the base station using RRC or DCI signaling, the HARQ timeline being for the maximum slot aggregation which is configured or activate for all transmissions,

wherein the HARQ timeline is the time taken from the time the DCI is received by the TX UE to the time the TX UE is ready to send a feedback to the base station, after it has received and decoded the transmission.

According to a thirty-fifth aspect, a wireless communication system may have: one or more base stations,

a plurality of user devices, UEs, to communicate with each other using a sidelink, SL, the plurality of UEs including a transmitting UE, TX UE, the TX UE to communicate with one or more receiving UEs, RX UEs, using the sidelink,

wherein the base station is to serve the TX UE,

wherein for a transmission of a packet, like a data packet, using the sidelink, the base station is to determine one or more transmission requirements for the transmission of the data packet using the sidelink, and, responsive to the one or more determined transmission requirements, the base station is to send to the TX UE one or more control messages, the one or more control messages including one or more of:
a common control message including parameters for a HARQ-based transmission using the sidelink and for a blind or HARQ-free transmission using the sidelink, or
a control message for HARQ-based retransmissions including parameters for a HARQ-based transmission using the sidelink, or
a control message for HARQ-free retransmissions including parameters for a blind or HARQ-free transmission using the sidelink,

wherein the TX UE is to receive from the base station the one or more control messages, and is to transmit one or more control messages to the RX UE, and is to then further transmit the packet to the RX UE in accordance with the parameters indicated in the one or more control messages.

According to a thirty-sixth aspect, a wireless communication system may have: one or more base stations according to any one of the first to twenty-seventh aspects,

a plurality of user devices, UEs, to communicate with each other using a sidelink, SL, the plurality of UEs including a transmitting UE, TX UE, according to any one of the twenty-eighth to thirty-fourth aspects, the TX UE served by the base station and to communicate with one or more receiving UEs, RX UEs, using the sidelink,

wherein the TX UE is to receive from the base station the one or more control messages, and is to transmit one or more control messages to the RX UE, and is to then further transmit the packet to the RX UE in accordance with the parameters indicated in the one or more control messages.

According to a thirty-seventh aspect when referring back to the thirty-fifth or thirty-sixth aspect, the base station is to send to the TX UE a single DCI indicating a HARQ-based transmission, transmission and/or retransmission resource locations and a single PUCCH location,

the TX UE is to send to the RX UE a single SCI,

the RX UE is to send to the TX UE single HARQ feedback, wherein the RX UE is to combine all the received retransmissions, and to send a HARQ feedback only after successfully decoding the packets or after the maximum number of retransmissions, and

wherein the TX UE is to relay to the base station a single HARQ feedback using the single PUCCH resource defined in the single DCI.

According to a thirty-eighth aspect when referring back to the thirty-fifth or thirty-sixth aspect, the base station is to send to the TX UE a single DCI indicating a HARQ-based transmission and including a single PUCCH location for the transmission and/or retransmission resource locations,

the TX UE is to send to the RX UE a single SCI,

the TX UE is to receive multiple HARQ feedbacks from the RX UE, but informs the base station only when the RX UE successfully decodes the packet,

wherein the TX UE may schedule a CBG-based transmission including, e.g., several code blocks which are grouped in CBGs, Code Block Groups, to the RX UE using a single SCI, so as to expect multiple feedbacks, e.g., one per each CBG

According to a thirty-ninth aspect when referring back to the thirty-eighth aspect, the TX UE is to stop sending retransmissions once the RX UE has responded with a positive ACK.

According to a fortieth aspect when referring back to the thirty-fifth or thirty-sixth aspect, the base station is to send to the TX UE a single DCI indicating a HARQ-based transmission and including a single PUCCH location for the transmission and/or retransmission resource locations,

the TX UE is to send to the RX UE multiple SCIs with retransmission resource locations in each SCI,

the RX UE is to combine all the received retransmissions, and is to send a HARQ feedback only after successfully decoding the packets, or after the maximum number of retransmissions, or after a configured or pre-configured number of retransmissions;

the TX UE is to relay to the base station a single HARQ feedback using the single PUCCH resource defined in the single DCI.

According to a forty-first aspect when referring back to the thirty-fifth or thirty-sixth aspect, the base station is to send to the TX UE a single DCI indicating a HARQ-based transmission and including a single PUCCH location for the transmission and/or retransmission resource locations,

the TX UE is to send multiple SCIs with retransmission resource locations in each of the SCIs;

the RX UE is to combine the received transmissions defined in a given SCI, and is to send a HARQ feedback based on the transmissions defined in that SCI;

the TX UE is to relay to the base station a single HARQ feedback using the single PUCCH resource defined in the single DCI.

According to a forty-second aspect when referring back to the forty-first aspect, the TX UE is to receive the feedback per SCI, and is to stop sending SCIs once the RX UE has responded with a positive ACK.

According to a forty-third aspect when referring back to the thirty-fifth or thirty-sixth aspect, the base station is to send to the TX UE a single DCI indicating a HARQ-based transmission and including a single PUCCH location for the transmission and/or retransmission resource locations,

the TX UE is to send multiple SCIs with retransmission resource locations in each of the SCIs;

the RX UE is to send a HARQ feedback for each of the transmissions,

the TX UE is to relay to the base station a single HARQ feedback using the single PUCCH resource defined in the single DCI.

According to a forty-fourth aspect when referring back to the forty-third aspect, the TX UE is to receive all the feedback, and is to stop sending retransmissions and further SCIs once the RX UE has responded with a positive ACK.

According to a forty-fifth aspect when referring back to the thirty-fifth or thirty-sixth aspect, the base station is to send to the TX UE multiple DCIs indicating a HARQ-based transmission, each including a single PUCCH location for the transmission and/or retransmission resource locations,

the TX UE is to send multiple SCIs with retransmission resource locations in each of the SCIs;

the RX UE is to combine the received transmissions defined in a given SCI, and is to send a HARQ feedback based on the transmissions defined in that SCI;

the TX UE is to receive the feedback per SCI, and is to relay to the base station the feedback using the PUCCH resource defined in the corresponding DCI,

wherein, to receiving a feedback indicating a successful decoding of the packed by the RX UE, the base station is to stop sending DCIs to the TX UE for the said packet.

According to a forty-sixth aspect when referring back to the thirty-fifth or thirty-sixth aspect, the base station is to send to the TX UE multiple DCIs indicating a HARQ-based transmission, each including a single PUCCH location for the transmission and/or retransmission resource locations,

the TX UE is to send multiple SCIs with retransmission resource locations in each of the SCIs;

the RX UE is to send a HARQ feedback for each of the transmissions;

the TX UE is to receive all the feedback, and to relay to the base station the feedback using the PUCCH resource defined in the corresponding DCI.

According to a forty-seventh aspect when referring back to the forty-sixth aspect, the TX UE is to stop SCIs once the RX UE has responded with a positive ACK, and wherein, responsive to the positive feedback, the base station is to stop sending DCIs to the TX UE for the said packet.

According to a forty-eighth aspect when referring back to any of the thirty-fifth to forty-seventh aspects, in case the DCI provides a resource allocation for the initial transmission and for the one or more retransmissions and for a feedback channel, e.g. PUCCH, for the initial transmission and for the one or more retransmissions, the base station, responsive to an ACK for one from the TX UE, is to invalidate all subsequent resource allocations, e.g., for rescheduling the invalidated resources to the same or to another SL UE.

According to a forty-ninth aspect when referring back to any of the thirty-fifth to forty-eighth aspects, based on the information provided to the TX UE on a DCI by the base station, the resources are defined in the SCI by one or more of the following:
in case the frequency location or subchannel of the initial transmission and the one or more retransmissions are the same, the resources are defined by at least one of
a bitmap indicating the time slots in which the retransmissions occur, e.g., in the form of a vector or in the form of an index mapped to a table in the RX UE containing multiple bitmap vectors,
a timing offset, where the RX UE can then derive the time slots in which the retransmissions occur.
in case the frequency locations or subchannels of the initial transmission and the one or more retransmissions are different, the resources are defined by a time-frequency pattern indicating the time and frequency locations of the resources, e.g., in the form of an index mapped to a table in the RX UE containing multiple time-frequency patterns,
Slot aggregation parameter indicating the number of aggregated slots,
DAI parameters.

According to a fiftieth aspect when referring back to any of the thirty-fifth to forty-ninth aspects, when using configured grants, in case some grants contain information regarding the PUCCH and some do not contain information regarding the PUCCH, the TX UE is to
use that the grants that contain PUCCH resources to send feedback back to the base station, and
use the grants that contain no PUCCH resources for blind transmissions.

According to a fifty-first aspect when referring back to any of the thirty-fifth to fiftieth aspects, when using configured grants, the TX UE is to decide on which grant to transmit the packet dependent on the characteristics of the grant, e.g., dependent on a quality of the resources, the TX UE may use a grant for packets requiring a high or low priority and/or reliability and/or latency.

According to a fifty-second aspect when referring back to any of the thirty-fifth to fiftieth aspects, when using configured grants, the TX UE is to decide on which grant to transmit the packet dependent on the communication type, e.g., dependent on a conditions of the resources, the TX UE may use a grant for packets related to broadcast, groupcast or unicast transmissions.

According to a fifty-third aspect when referring back to any of the thirty-fifth to fifty-second aspects, the UE comprise one or more of
a mobile terminal, or
stationary terminal, or
cellular IoT-UE, or
vehicular UE, or
vehicular group leader (GL) UE
an IoT or narrowband IoT, NB-IoT, device, or
a ground based vehicle, or
an aerial vehicle, or
a drone, or
a moving base station, or
road side unit (RSU), or
a building, or
any other item or device provided with network connectivity enabling the item/device to communicate using the wireless communication network, e.g., a sensor or actuator, or
any other item or device provided with network connectivity enabling the item/device to communicate using a sidelink the wireless communication network, e.g., a sensor or actuator, or
any sidelink capable network entity, and/or
wherein the base station comprises one or more of
a macro cell base station, or
a small cell base station, or
a central unit of a base station, or
a distributed unit of a base station, or
a road side unit (RSU), or
a UE, or
a group leader (GL)
a relay or
a remote radio head, or
an AMF, or
an SMF, or
a core network entity, or
mobile edge computing (MEC) entity, or
a network slice as in the NR or 5G core context, or
any transmission/reception point, TRP, enabling an item or a device to communicate using the wireless communication network, the item or device being provided with network connectivity to communicate using the wireless communication network.

According to a fifty-fourth aspect, a method for operating a transceiver in a wireless communication system, the wireless communication system including a plurality of user devices, UEs, to communicate with each other using a sidelink, SL, may have the steps of:

for a transmission of a packet, like a data packet, using the sidelink, the transceiver is to determine one or more transmission requirements for the transmission of the data packet using the sidelink,

responsive to the one or more determined transmission requirements, sending one or more control messages, the one or more control messages including one or more of:
a common control message including parameters for a HARQ-based transmission using the sidelink and for a blind or HARQ-free transmission using the sidelink, or
a control message including parameters for a HARQ-based transmission using the sidelink, and a control message including parameters for a blind or HARQ-free transmission using the sidelink.

According to a fifty-fifth aspect, a method for operating a user device in a wireless communication system, the wireless communication system including a plurality of user devices, UEs, to communicate with each other using a sidelink, SL, wherein the user device is a transmitting user device, TX UE, served by a base station of the wireless communication system, may have the steps of:

communicating, with the TX UE with one or more receiving user devices, RX UEs, using the sidelink, and

for a transmission of a packet, like a data packet, using the sidelink, receive, with the TX UE, from the serving base station, dependent on one or more transmission requirements

for the transmission of the data packet, one or more control messages, like a DCI, the one or more control messages including one or more of:
common DCI including parameters for a HARQ-based transmission using the sidelink and for a blind or HARQ-free transmission using the sidelink, or
DCI for HARQ-based retransmissions including parameters for a HARQ-based transmission using the sidelink, or
DCI for HARQ-free retransmissions including parameters for a blind or HARQ-free transmission using the sidelink.

According to a fifty-sixth aspect, a method for operating a wireless communication system comprising one or more base stations, a plurality of user devices, UEs, to communicate with each other using a sidelink, SL, the plurality of UEs including a transmitting UE, TX UE, the TX UE to communicate with one or more receiving UEs, RX UEs, using the sidelink, may have the steps of:

serving the TX UE with the base station,

for a transmission of a packet, like a data packet, using the sidelink, determining, with the base station, one or more transmission requirements for the transmission of the data packet using the sidelink, and, responsive to the one or more determined transmission requirements, sending, with the base station, to the TX UE one or more control messages, the one or more control messages including one or more of:
a common control message including parameters for a HARQ-based transmission using the sidelink and for a blind or HARQ-free transmission using the sidelink, or
a control message for HARQ-based retransmissions including parameters for a HARQ-based transmission using the sidelink, or
a control message for HARQ-free retransmissions including parameters for a blind or HARQ-free transmission using the sidelink, receiving, with the TX UE, from the base station the one or more control messages, and transmitting, with TX UE, one or more control messages to the RX UE, and then further transmit the packet with the TX UE to the RX UE in accordance with the parameters indicated in the one or more control messages.

According to a fifty-seventh aspect, a method for operating a wireless communication system, comprising one or more base stations according to any one of the firth to twenty-fifth aspects, a plurality of user devices, UEs, to communicate with each other using a sidelink, SL, the plurality of UEs including a transmitting UE, TX UE, according to any one of the twenty-sixth to thirty-second aspects, may have the steps of:

serving the TX UE by the base station and communicating, with the TX UE, with one or more receiving UEs, RX UEs, using the sidelink,

receiving, with TX UE, from the base station the one or more control messages, and transmitting, with the TX UE, one or more control messages to the RX UE, and then further transmitting the packet with the TX UE to the RX UE in accordance with the parameters indicated in the one or more control messages.

According to a fifty-eighth aspect, a non-transitory computer program product may have a computer readable medium storing instructions which, when executed on a computer, perform the method of any one of the fifty-fourth to fifty-seventh aspects.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

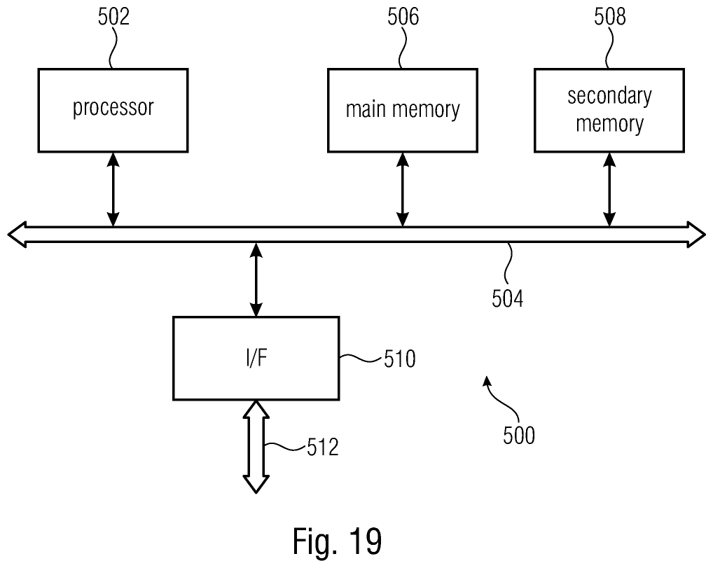

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 19 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein.

The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### List of Acronyms and Symbols

BS Base Station
CBR Channel Busy Ratio
CP Cyclic Prefix
D2D Device-to-Device
DCI Downlink Control Information
EN Emergency Notification
eNB Evolved Node B (base station)
IE Information Element
ITS Intelligent Transport Services
FDM Frequency Division Multiplexing
FR1, FR2 Frequency Range Designations
LTE Long-Term Evolution
M1, M2 Mode 1, Mode 2
PC5 Interface using the Sidelink Channel for D2D communication
PPPP ProSe per packet priority
PRB Physical Resource Block
ProSe Proximity Services
PSCCH Physical Sidelink Control Channel
PSSCH Physical Sidelink Shared Channel
RA Resource Allocation
RB Resource Block
SCI Sidelink Control Information
SCS Sub Carrier Spacing
SL sidelink
sTTI Short Transmission Time Interval
TDM Time Division Multiplexing
TDMA Time Division Multiple Access
TPC Transmit power control/transmit power command
TTI User Entity (User Terminal)
UE Transmit Time-Interval
URLLC Ultra-Reliable Low-Latency Communication
V2V Vehicle-to-vehicle
V21 Vehicle-to-infrastructure
V2P Vehicle-to-pedestrian
V2N Vehicle-to-network
V2X Vehicle-to-everything, i.e., V2V, V21, V2P, V2N
3GPP Third Generation Partnership Project

1. A transceiver for a wireless communication system, the wireless communication system comprising a plurality of user devices, UEs, to communicate with each other using a sidelink, SL, wherein
for a transmission of a packet, like a data packet, using the sidelink, the transceiver is to determine one or more transmission requirements for the transmission of the data packet using the sidelink,
responsive to the one or more determined transmission requirements, the transceiver is to send one or more control messages, comprising a common control message comprising parameters for a HARQ-based transmission using the sidelink and for a blind or HARQ-free transmission using the sidelink.

2. The transceiver of claim 1, wherein
the transceiver is a base station of the wireless communication system communicating with a transmitting UE, TX UE, using the Uu link, the TX UE communicating with one or more receiving UEs, RX UEs, using the sidelink, the transmitting and/or receiving UEs being in NR Mode 1.

3. The transceiver of claim 2, wherein each of the one or more control messages comprises common control message parameters, the common control message parameters comprising one or more of:
a resource location indication,
transmission procedure indicator e.g. blind-transmission or retransmission, or HARQ enabled transmission,

4. The transceiver of claim 2, wherein the common control message comprises one or more of:
a retransmission type indication indicating whether the one or more retransmissions over the sidelink are HARQ-based retransmissions or blind retransmissions,
a Downlink Assignment Index, DAI,
a retransmission feedback resource location indication indicating the resource locations for transmitting a feedback from the TX UE to the base station, e.g., on the PUCCH.

5. The transceiver of claim 4, wherein the retransmission type indication is
explicit and comprises an explicit parameter indicating whether the packet to be transmitted uses HARQ-based retransmissions or blind retransmissions, or
is implicit by setting one or more certain parameters in the DCI to a predefined or default value

6. The transceiver of claim 5, wherein, in case of an implicit retransmission type indication
the use of blind retransmissions is indicated by
using a non-numerical value or a default or pre-configured value for parameters indicating the resources to be used for a feedback from the TX UE to the base station, e.g., in the PUCCH, like a PUCCH resource indicator, or a time gap between the DCI and the feedback, e.g. on the PUCCH, like a PSSCH/PDCCH-to-HARQ-timing indicator, or
a resource location indication for the transmissions and/or retransmissions which points to a set of resources or to a resource pool not including any resources for a PSFCH, and/or
the use of HARQ-based retransmissions is indicated by
a resource location indication for the transmissions and/or retransmissions which points to a set of resources or to a resource pool including resources for a PSFCH;
and/or the use of the destination ID, priority information or cast type e.g. transmission resources for broadcast or a destination ID that has no HARQ configured.

7. The transceiver of claim 4, wherein the transceiver is to
receive from the TX UE an ACK in case the TX UE determines that all allowable transmissions and/or retransmissions for the packet are completed or
receive an explicit parameter indicating that all allowable transmissions and/or retransmissions for the packet are completed.

8. The transceiver of claim 7, wherein the transceiver in response to the ACK or the explicit indication, indicating that the transmissions and/or retransmissions for the packet are complete, will stop allocating further resources for the packet, independent from the feedback on the PSFCH.

9. The transceiver of claim 1, wherein
the transceiver is a transmitting UE, TX UE, communicating with one or more receiving UEs, RX UEs, using the sidelink, the transmitting and/or receiving UEs being in NR Mode 2, and
the one or more control messages are sidelink control information, SCI, messages comprising sidelink control information, SCI.

10. A user device for a wireless communication system, the wireless communication system comprising a plurality of user devices, UEs, to communicate with each other using a sidelink, SL, wherein
the user device is a transmitting user device, TX UE, served by a base station of the wireless communication system, and is to communicate with one or more receiving user devices, RX UEs, using the sidelink, and
for a transmission of a packet, like a data packet, using the sidelink, the TX UE is to receive from the serving base station, dependent on one or more transmission requirements for the transmission of the data packet, one or more control messages, like a DCI, the one or more control messages comprising common DCI comprising parameters for a HARQ-based transmission using the sidelink and for a blind or HARQ-free transmission using the sidelink.

11. The user device of claim 10, wherein the serving base station comprises or is a transceiver according to claim 1.

12. The user device of claim 10, wherein, responsive to the common DCI, the TX UE is expected to send at least one of the following:
a single SCI with all the resource locations, with an indication that the feedback for each of the transmissions has to be sent, or
multiple SCIs comprising a further subset of the resource locations described in the DCI, and specify that feedback has to be sent for each of the transmissions, and
wherein TX UE, on receiving the feedback from the RX UE per transmission, will provide the feedback to the base station on the PUCCH resources, which are either implicitly derived or explicitly indicated in the DCI, for the transmission.

13. The user device of claim 11, wherein, responsive to the common DCI, the TX UE is expected to send the single SCI as an SCI comprising at least two stages.

14. The user device of claim 10, wherein the DCI comprises a downlink assignment index, DAI, the DAI comprises a counter DAI, cDAI, to be incremented by the base station in case the DCI is for a HARQ-based retransmission and in case the DCI is for a blind retransmission,
wherein the TX UE is to send an ACK to the base station in order to signal to the base station that no further resources are required for the given transmission.

15. The user device of claim 14, wherein the DCI comprises a downlink assignment index, DAI, the DAI comprises a counter DAI, cDAI, to be incremented by the base station in case the DCI is for a HARQ-based retransmission and in case the DCI is for a blind retransmission,
wherein the TX UE is to send an NACK to the base station in order to signal that it did not receive the DCI correctly and/or that it needs more resources from the base station.

16. A wireless communication system, comprising
one or more base stations according to claim 1,
a plurality of user devices, UEs, to communicate with each other using a sidelink, SL, the plurality of UEs comprising a transmitting UE, TX UE, according to claim 10, the TX UE served by the base station and to communicate with one or more receiving UEs, RX UEs, using the sidelink,
wherein the TX UE is to receive from the base station the one or more control messages, and is to transmit one or more control messages to the RX UE, and is to then further transmit the packet to the RX UE in accordance with the parameters indicated in the one or more control messages.

17. The wireless communication system of claim 16, wherein
the base station is to send to the TX UE a single DCI indicating a HARQ-based transmission and comprising a single PUCCH location for the transmission and/or retransmission resource locations,
the TX UE is to send multiple SCIs with retransmission resource locations in each of the SCIs;
the RX UE is to send a HARQ feedback for each of the transmissions,
the TX UE is to relay to the base station a single HARQ feedback using the single PUCCH resource defined in the single DCI.

18. The wireless communication system of claim 17, wherein the TX UE is to receive all the feedback, and is to stop sending retransmissions and further SCIs once the RX UE has responded with a positive ACK.

19. The wireless communication system of claim 16, wherein, in case the DCI provides a resource allocation for the initial transmission and for the one or more retransmissions and for a feedback channel, e.g. PUCCH, for the initial transmission and for the one or more retransmissions, the base station, responsive to an ACK for one from the TX UE, is to invalidate all subsequent resource allocations, e.g., for rescheduling the invalidated resources to the same or to another SL UE.
